(19) United States
(12) Patent Application Publication
(10) Pub. No.: US 2022/0380591 A1
(43) Pub. Date: Dec. 1, 2022

(54) CURABLE COMPOSITIONS WITH ACRYLIC AND SILICONE RESINS

(71) Applicant: BASF SE, Ludwigshafen am Rhein (DE)

(72) Inventors: Kevin PAYNE, Wyandotte, MI (US); Debra Dorschel HALLOCK, Charlotte, NC (US); Armin A. BURGHART, Charlotte, NC (US)

(21) Appl. No.: 17/762,394

(22) PCT Filed: Sep. 18, 2020
(86) PCT No.: PCT/US2020/051653

§ 371 Date: Mar. 22, 2022

Related U.S. Application Data
(60) Provisional application No. 62/904,943, filed on Sep. 24, 2019.

(51) Int. Cl. C08L 43/04; C08L 83/04; C09J 143/04; C09J 183/04

(52) U.S. Cl. CPC C08L 43/04; C08L 83/04; C09J 143/04; C09J 183/04

(57) ABSTRACT

Hybrid moisture curable compositions comprising an acrylic copolymer, a functional silicone, a crosslinker, and a moisture cure catalyst are disclosed. The acrylic copolymer includes (i) a functional monomer selected from a silane monomer, a siloxane monomer, a hydroxy functional monomer, or a combination thereof or (ii) a reaction product of an amino silane and an acrylic polymer derived from one or more (meth)acrylates and one or more carboxylic acid anhydrides. The hybrid compositions are stable and exhibit properties typically ascribed to each individual polymer component. Methods of making and using the hybrid curable compositions are also described.

### FIELD OF THE DISCLOSURE

The present disclosure relates to curable compositions, particularly to hybrid curable compositions including a modified (meth)acrylic copolymer and a silicone polymer.

### BACKGROUND

Curable polymers such as silicones, polyurethanes, and acrylics are used in a variety of applications. For example, roof coatings based on silicone and urethane chemistry have been used for many years. The unique advantage of acrylic dispersions in relation to surface coatings is their ability to form a coherent film. Acrylic films are also waterproof and provide good resistance to mechanical and chemical damage. Silicone coatings are known for their ability to allow for expansion and contraction, a great benefit during drastic seasonal changes. Polyurethane coatings are known for their flexibility. These features allow silicones, polyurethanes, and acrylics to be employed in surface coating applications, especially roof coatings. Relatively high raw material cost in comparison with a typical acrylic emulsion has restricted silicone and polyurethane use in many industrial applications. To overcome this, blended dispersions have been sought to obtain a cost/performance balance. In such blends, however, the performance properties of the polymers may be compromised because of the incompatibility of the two materials. Incompatibility has also been observed when re-coating a surface with a polymer other than what was previously present.

There is a need to solve the problem of providing hybrid dispersions that when formulated into coatings, provide improved binding affinity to the surface and/or to coatings that may have been previously applied. There is also a need to provide surface coatings with improved properties in terms of adhesion, film-formability, flexibility, non-stickiness, weather-resistance, elongation, and strength with excellent cost-performance balance. The compositions and methods described herein address these and other needs.

### SUMMARY OF THE DISCLOSURE

Disclosed herein are hybrid moisture curable compositions. The hybrid moisture curable compositions comprise a) an acrylic copolymer derived from (i) a functional monomer selected from a silane monomer, a siloxane monomer, a hydroxy functional monomer, or a combination thereof, or (ii) a reaction product of an aminosilane and an acrylic polymer derived from one or more (meth)acrylates and one or more carboxylic acid anhydrides b) a functional silicone, c) a crosslinker, and d) a moisture cure catalyst. For example, the hybrid compositions can include a silyl-acrylate copolymer, a functional silicone, a silane crosslinker, and the moisture cure catalyst. The silane functionality on the acrylic copolymer imparts the ability to chemically crosslink with the silicone-based building blocks of the functional silicone polymer. The hybrid compositions disclosed herein exhibit properties typically ascribed to each individual polymer component. For example, the compositions are expected to provide the advantages of polyacrylates, such as good cohesive strength, excellent weather resistance, durability, adhesion, as well as lower cost, and the advantages of silicones, such as improved water resistance and chemical resistance.

In certain embodiments, the acrylic copolymer can be derived from monomers including a (meth)acrylate monomer and an organosilane or an organosiloxane monomer. Examples of organosilane and organosiloxane monomers include a vinyl silane, a silane (meth)acrylic monomer, a siloxane (meth)acrylic monomer, or a combination thereof. In some examples, the acrylic copolymer can include an organosilane or organosiloxane monomer selected from a trialkoxylsilyl (meth)acrylate such as (3-methacryloxypropyl)-trimethoxysilane, (3-methacryloxypropyl)-triethoxysilane, (3-methacryloxypropyl)-triisopropoxysilane; a dialkoxylsilyl (meth)acrylate such as (3-methacryloxypropyl)-methyldiethoxysilane, dimethoxymethylsilyl methyl (meth)acrylate, or diethoxymethylsilyl methyl (meth)acrylate; a vinyltrialkoxysilane such as vinyltrimethoxysilane, vinyltriethoxysilane, vinyl triisopropoxysilane, or vinyl tris(2-methoxyethoxysilane); 2-methyl-2-propenoic acid 3-[tris-(1-methylethoxy)-silyl]-propyl ester; or a combination thereof. The acrylic copolymer can be derived from greater than 0% to 15% by weight, preferably from 1% to 10% by weight, more preferably from 1% to 7% by weight, of the organosilane or organosiloxane monomer, based on a total weight of monomers in the acrylic copolymer.

In other certain embodiments, the acrylic copolymer is a reaction product of an aminosilane and an acrylic polymer derived from one or more (meth)acrylates and one or more carboxylic acid anhydrides. The reaction of the aminosilane and the acrylic polymer can be performed post polymerization of the acrylic polymer to form the acrylic copolymer prior to mixing with the functional silicone, the crosslinker, and/or moisture cure catalyst. In other embodiments, the reaction of the aminosilane and the acrylic polymer can be carried out to form the acrylic copolymer in situ, that is, the aminosilane is added to a mixture comprising the acrylic polymer and one or more of the functional silicone, crosslinker, and/or moisture cure catalyst. In these embodiments, the aminosilane is pendant from the acrylic copolymer backbone.

The aminosilane can have a structure represented by the general Formula I:

H₂N—(R¹)—Si(R²)₃ Formula I

wherein R¹ and R² are independently for each occurrence, selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group, and wherein at least one occurrence of R² is a C₁-C₁₀ alkoxy group. In some examples, the aminosilane can be selected from 3-aminopropylmethyldiethoxysilane, 3-aminopropyltrimethoxysilane, 3-aminopropyltriethoxysilane, N-(2-aminoethyl-3-aminopropyl)-trimethoxysilane, or combinations thereof. The acrylic copolymer can be derived from greater than 0% to 10% by weight, preferably from 1% to 5% by weight of the aminosilane, based on the total weight of monomers in the acrylic copolymer. The one or more carboxylic acid anhydrides present in the acrylic copolymer can be selected from the group consisting of a (meth)acrylic anhydride, an itaconic anhydride, a citraconic anhydride, a maleic anhydride, and a combination thereof. The acrylic copolymer can be derived from greater than 0% to 15% by weight, preferably from 1% to 10% by weight, more preferably from 1% to 5% by weight, of the one or more carboxylic acid anhydrides, based on the total weight of monomers in the acrylic copolymer.

In further embodiments, the acrylic copolymer can be derived from monomers including a (meth)acrylate monomer and a hydroxy functional monomer. Examples of hydroxy functional monomers include hydroxyethyl acrylate, hydroxypropyl acrylate, hydroxy methylethyl acrylate, hydroxyethyl acrylamide, hydroxybutyl acrylate, hydroxyethyl methacrylate, hydroxyethyl methacrylate, hydroxypropyl methacrylate, glycerol monomethacrylate, hydroxypropyl)methacrylamide, or a combination thereof. The acrylic copolymer can be derived from greater than 0% to 30% by weight, preferably from 1% to 20% by weight, more preferably from 3% to 12% by weight, of the hydroxy functional monomer, based on a total weight of monomers in the acrylic copolymer.

As described herein, the acrylic copolymer can include one or more (meth)acrylates. The one or more (meth)acrylates can be selected from butyl acrylate, ethyl acrylate, 2-ethylhexyl acrylate, methyl methacrylate, or combinations thereof. The acrylic copolymer can be derived from 60% to 95% by weight, from 75% to 90% by weight, or from 75% to 85% by weight of the one or more (meth)acrylates, based on the total weight of monomers in the acrylic copolymer. The acrylic copolymer can further comprise one or more additional monomers selected from an ethylenically unsaturated carboxylic acid monomers, a (meth)acrylamide, a styrene, a hydroxyethyl acrylate, or a combination thereof.

The acrylic copolymer can have a measured T_{g} of from −60° C. to 40° C., such as from −60° C. to 30° C., from −60° C. to 10° C., from −50° C. to less than 10° C., or from −50° C. to less than 0° C. The acrylic copolymer can have a weight average molecular weight of from 1,000 Daltons to 20,000 Daltons, from 2,000 Daltons to 15,000 Daltons, or from 4,000 Daltons to 13,000 Daltons.

The hybrid moisture curable compositions further include a silicone polymer comprising a functional group. The functional group can be selected from a hydroxyl functional group, an amine functional group, a thiol functional group, an alkoxy functional group, a hydride functional group, a vinyl functional group, or a mixture thereof. Preferably, the functional silicone polymer comprises a hydroxyl functional group, an amine functional group, a thiol functional group, and/or an alkoxy functional group. The functional silicone polymer can comprise a polysiloxane backbone, such as a polydialkylsiloxane backbone. Examples of polydialkylsiloxane include polydimethylsiloxane. The functional silicone polymer can have a viscosity of up to 3,000,000 cp, such as up to 2,000,000 cp, or from about 100 cp to 100,000 cp.

The acrylic copolymer and the functional silicone polymer can be present in the hybrid curable compositions in a weight ratio of from 1:5 to 5:1, preferably from 1:3 to 3:1, more preferably from 1:2 to 2:1, based on the total weight of the composition. In certain embodiments, the acrylic copolymer can be present in an amount of from 5% to 80% by weight, preferably from 10% to 60% by weight, more preferably from 20% to 50% by weight, based on a total weight of the composition. In certain embodiments, the functional silicone polymer is present in an amount of from 5% to 80% by weight, preferably from 10% to 60% by weight, more preferably from 20% to 50% by weight, based on the total weight of the composition.

As described herein, the hybrid curable compositions further include a crosslinker. In some embodiments, the crosslinker can be a silane based crosslinker, such as an acetoxy silane crosslinker, an oximino silane based crosslinker, a methylethylketoxime (MEKO) based crosslinker, a methylisobutylketoxime (MIBKO) based crosslinker, an acetoxime based crosslinker, an alkoxy silane based crosslinker, or a combination thereof. In some examples, the crosslinker includes a methyl tris(MEKO)silane, a tetra(MEKO)silane, a vinyl tris(MEKO)silane, a methylvinyl di(MEKO)silane, a phenyl tris(MEKO)silane, a methyl tris(MIBKO)silane, a tetra(MIBKO)silane, a vinyl tris(MIBKO)silane, a methyl tris(acetoxime)silane, a vinyl tris(acetoxime)silane, or a mixture thereof. The crosslinker can be present in an amount of up to 10% by weight up to 5% by weight, from 0.1% to 10% by weight, from 0.5% to 10% by weight, or from 1% to 5% by weight, based on the total weight of the composition.

The moisture cure catalyst can include a Lewis acid catalyst. For example, the moisture cure catalyst can include a metal carboxylate, a metal alkoxide, or a mixture thereof. In certain embodiments, the hybrid curable compositions are free of a scrambling catalyst, such as a scrambling catalyst having a pKa value equal to or less than −6 or equal to or greater than 15. Scrambling catalysts can be selected from KOH, NaOH, LiOH, organolithium reagents, Grignard reagents, methanesulfonic acid, sulfuric acid, acidic clay, acidic ion exchange resins, and mixtures thereof.

In addition to the acrylic copolymer, functional silicone, crosslinker, and moisture cure catalyst, the hybrid curable compositions can further comprise a filler, an adhesion enhancer, a water scavenger, a film forming aid, a defoamer, a thickener, a tackifier, or a combination thereof. The inorganic filler can be selected from calcium carbonate, titanium dioxide, kaolin, bentonite, mica, talc, attapulgite, zeolite, a reinforcing filler (such as silica, preferably fused silica or fumed silica), or mixtures thereof. When present, the inorganic filler can be in an amount of from greater than 0% to 80%, preferably from 5% to 80%, more preferably from 20% to 75% by weight, of the total weight of the composition. The adhesion enhancer can include a vinyl organosilane, an aminosilane, an epoxysilane, or a combination thereof. When present, the adhesion enhancer can be in an amount of from 0.05% to 10% by weight, based on the total weight of the composition.

In some embodiments, the hybrid curable compositions include a water scavenger. The composition preferably comprises less than 0.1% by weight water, preferably less than 0.05% by weight water, and more preferably is anhydrous.

The hybrid curable compositions can have a Brookfield viscosity of from 10,000 cps to 50,000 cps, or from 25,000 cps to 50,000 cps, at 25° C. and 20 rpm using a #7 spindle prior to curing. The hybrid curable compositions when applied as a film and cured, can develop a tensile strength of at least 30 psi, preferably at least 40 psi after 5 days. The hybrid curable compositions when applied as a film and cured, can exhibit an elongation at break of at least 80%, preferably at least 100%, more preferably at least 120% after 5 days. The hybrid curable compositions when applied as a film and cured, can exhibit a water absorbance of less than 5%, preferably less than 2%, more preferably less than 0.5% after 3 days of soaking.

The hybrid curable compositions can be used as or as a component in adhesive compositions, sealants, water-proofing compositions, or roof coatings. In particular, roof coating compositions are described herein. Roof coatings, for example, can be formed from the reaction product of from 20-60% by weight of an acrylic copolymer; from 20-60% by weight of a functional silicone polymer; from 0.1-10% by weight of a silane based crosslinker; a moisture cure catalyst; and an inorganic filler. The coating compositions can develop a tack-free time of less than 24 hours at room temperature. The coating compositions can develop a tensile strength of at least 50 psi, preferably at least 90 psi, more preferably at least 100 psi after 5 days. The coating compositions can exhibit an elongation at break of at least 30%, preferably at least 70%, more preferably at least 100% after 5 days. The roof coating compositions can exhibit a water absorbance of less than 10%, preferably less than 5%, more preferably less than 3% after 7 days of soaking. The coating compositions can exhibit an adhesion rating of at least 5 on a silicone surface.

Methods of making the hybrid curable compositions disclosed herein are also described. The method can include mixing a) an acrylic copolymer derived from (i) a functional monomer selected from a silane monomer, a siloxane monomer, a hydroxy functional monomer, or a combination thereof, or (ii) a reaction product of an aminosilane and an acrylic polymer derived from one or more (meth)acrylates and one or more carboxylic acid anhydrides with b) a functional silicone polymer, c) a crosslinker, and d) a moisture cure catalyst to form a mixture, and allowing the mixture to cure. The acrylic copolymer, the functional silicone polymer, and the crosslinker can react to form a covalently bonded material. The method can further include adding a mineral filler, an adhesion enhancer, a water scavenger, plasticizer, a stabilizer, an antioxidant, a film forming aid, or a combination thereof, prior to allowing the mixture to cure.

Methods of coating a surface comprising applying a composition as disclosed herein to at least a portion of the surface and allowing the composition to cure, are also described. The surface can be a glass, a porcelain, a wood, a metal, a resin molded product, a roof material, a stone, a concrete, a mineral substrate, a ceramic, a coated surface such as a painted surface, or a plastic. In some examples, the surface is a coated surface, comprising a silicone coating or an acrylic coating.

The details of one or more embodiments are set forth in the description below. Other features, objects, and advantages will be apparent from the description and from the claims.

### DETAILED DESCRIPTION

The compositions and methods described herein may be understood more readily by reference to the following detailed description of specific aspects of the disclosed subject matter and the examples included therein.

Before the present compositions and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

In this specification and in the claims that follow, reference will be made to a number of terms, which shall be defined to have the following meanings.

Throughout the description and claims of this specification, the words “comprise,” “include,” and other forms of these words, such as “comprising,” “comprises,” “including,” and “includes” are open, non-limiting terms and do not exclude additional elements such as, for example, additional additives, components, integers, or steps. Although the terms “comprising” and “including” have been used herein to describe various embodiments, the terms “consisting essentially of” and “consisting of” can be used in place of “comprising” and “including” to provide for more specific embodiments and are also disclosed.

As used in the description and the appended claims, the singular forms “a,” “an,” and “the” include plural referents unless the context clearly dictates otherwise. Thus, for example, reference to “a composition” includes two or more compositions, reference to “an adhesion enhancer” includes two or more adhesion enhancers, reference to “the catalyst” includes two or more catalysts, and the like.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, “(meth)acryl . . . ” includes acryl . . . and methacryl . . . and also includes diacryl . . . , dimethacryl . . . and polyacryl . . . and polymethacryl . . . . For example, the term “(meth)acrylate monomer” includes acrylate and methacrylate monomers, diacrylate and dimethacrylate monomers, and other polyacrylate and polymethacrylate monomers.

Unless otherwise defined, weight percent is based on the dry weight of the component, such as the dry weight of the acrylic copolymer or the dry weight of the hybrid moisture curable composition.

The term “(co)polymer” includes homopolymers, copolymers, or mixtures thereof.

Disclosed herein are hybrid moisture curable compositions, also referred to herein as “hybrid curable compositions” or “compositions.” The hybrid curable compositions can include an acrylic copolymer comprising a reactive monomer, a functional silicone, a crosslinker, and a moisture cure catalyst.

Acrylic Copolymer

The acrylic copolymer in the hybrid curable compositions include (i) one or more functional monomers selected from a silane monomer, a siloxane monomer, a hydroxy functional monomer, or a combination thereof, and/or (ii) a reaction product of an aminosilane and an acrylic polymer derived from one or more (meth)acrylates and one or more carboxylic acid anhydrides. The acrylic copolymer further includes one or more (meth)acrylate monomers. In some examples, the acrylic copolymer in the hybrid curable compositions include a silane monomer. For example, the acrylic copolymer can be derived from monomers including one or more (meth)acrylate monomers and one or more organosilane monomers or one or more organosiloxane monomers.

The silane monomer in the acrylic copolymer can be represented by the formula

(R¹)—(Si)—(OR²)₃

wherein R¹ and R² are independently for each occurrence, selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group. In some embodiments, R¹ is a C₁-C₈ substituted or unsubstituted alkyl, a C₂-C₈ substituted or unsubstituted alkenyl, a C₁-C₁₀ alkoxy group, or a C₁-C₁₀ alkylamino group; and R², which can be the same or different, each is a C₁-C₈ substituted or unsubstituted alkyl group.

In certain embodiments, the silane monomer can be represented by the formula

(R¹)—Si—(R²)₃

wherein R¹ is a vinyl containing group or a (meth)acryl group; and R² for each occurrence, is independently selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group.

In some examples, the silane monomer can include an organosilane or organosiloxane monomer selected from a vinyl silane, a silane (meth)acrylic monomer, a siloxane (meth)acrylic monomer, or a combination thereof. For example, the organosilane monomer can include vinyltrimethoxysilane, vinyltriethoxysilane, vinyl tris(2-methoxyethoxysilane), vinyl triisopropoxysilane, (meth)acryloyloxypropyl trimethoxysilane, 7-(meth)acryloxypropyl trimethoxysilane, 7-(meth)acryloxypropyl triethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, or a mixture thereof. In some examples, the organosilane comprises vinyltrimethoxysilane, vinyltriethoxysilane, vinyl tris(2-methoxyethoxysilane), vinyl triisopropoxysilane, gamma-methacryloxypropyltrimethoxy silane, or combinations thereof. In some examples, the organosilane consists of vinylethoxysilane.

The acrylic copolymer can be derived from greater than 0% such as 0.05% or more by weight of the silane monomer (such as an organosilane or organosiloxane monomer), based on the total weight of monomers in the acrylic copolymer. In certain embodiments, the acrylic copolymer can be derived from 0.1% or more, 0.2% or more, 0.3% or more, 0.4% or more, 0.5% or more, 0.6% or more, 0.7% or more, 0.8% or more, 0.9% or more, 1% or more, 1.1% or more, 1.2% or more, 1.3% or more, 1.4% or more, 1.5% or more, 1.8% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, 9% or more, 10% or more, 11% or more, 12% or more, or 14% or more silane monomer (such as an organosilane or organosiloxane monomer), based on the total weight of monomers in the acrylic copolymer. In some examples, the acrylic copolymer can be derived from 15% or less by weight of the silane monomer (such as an organosilane or organosiloxane monomer), based on the total weight of monomers in the acrylic copolymer (e.g., 13% or less, 12% or less, 10% or less, 9% or less, 8% or less, 7% or less, 6% or less, 5.5% or less, 5% or less, 4.5% or less, 4% or less, 3.5% or less, 3% or less, 2.5% or less, 2% or less, or 1.5% or less). The amount of silane monomer (such as an organosilane or organosiloxane monomer) the acrylic copolymer is derived from can range from any of the minimum values described above to any of the maximum values described above. For example, the acrylic copolymer can be derived from greater than 0% to 15% by weight of the silane monomer (such as an organosilane or organosiloxane monomer), based on the total weight of monomers in the acrylic copolymer (e.g., from 1% to 15%, from 1% to 10%, from 1.5% to 8%, or from 1.5% to 5%).

In some embodiments, acrylic copolymer can include a reaction product of an aminosilane and an acrylic polymer derived from one or more (meth)acrylates and one or more carboxylic acid anhydrides. The aminosilane can be represented by the formula

H₂N—R¹—Si(R²)₃,

wherein R¹ and R² are independently, for each occurrence, selected from a C₁-C₁₀ alkyl group, a C₂-C₁₀ alkenyl group, a C₁-C₁₀ alkoxy group, a C₁-C₁₀ alkylthio group, and a C₁-C₁₀ alkylamino group. In some instances, at least one occurrence of R² can be a C₁-C₁₀ alkoxy group. Exemplary aminosilanes can include 3-aminopropylmethyldiethoxysilane, 3-aminopropyltrimethoxysilane, 3-aminopropyltriethoxysilane, N-(2-aminoethyl-3-aminopropyl)-trimethoxysilane, or combinations thereof.

The aminosilane can be reacted with the acrylic polymer derived from one or more (meth)acrylates and one or more carboxylic acid anhydrides to form the acrylic copolymer prior to mixing with the functional silicone, crosslinker, and/or moisture cure catalyst. In other embodiments, the aminosilane can be reacted with the acrylic polymer derived from one or more (meth)acrylates and one or more carboxylic acid anhydrides to form the acrylic copolymer in situ, in the presence of the functional silicone, crosslinker, and/or moisture cure catalyst. Accordingly, the acrylic copolymer comprising the aminosilane is formed in situ while mixing the hybrid curable composition. The aminosilane can react with the carboxylic acid anhydride monomers present in the acrylic polymer backbone, this forming a group pendant from the acrylic copolymer backbone. In some embodiments, a portion of the aminosilane can be present in the composition but do not covalently bind to the acrylic copolymer.

When present in the acrylic polymer, the carboxylic acid anhydride generally has ethylenic unsaturation and can, for example, be derived from a monocarboxylic acid, a dicarboxylic acid, or a combination thereof. Examples of suitable carboxylic anhydrides include, but are not limited to, (meth)acrylic anhydride, maleic anhydride, itaconic anhydride, citraconic anhydride, and combinations thereof. In some examples, the carboxylic acid anhydride can be selected from the group consisting of itaconic anhydride, maleic anhydride, and combinations thereof. In some examples, the carboxylic acid anhydride includes maleic anhydride. The acrylic copolymer can, for example, be derived from greater than 0% by weight of the carboxylic acid anhydride, based on the total weight of monomers in the acrylic polymer (e.g., 0.1% or more, 0.25% or more, 0.5% or more, 0.75% or more, 1% or more, 1.5% or more, 2% or more, 2.5% or more, 3% or more, 3.5% or more, 4% or more, 4.5% or more, 5% or more, 6% or more, 7% or more, or 8% or more). In some examples, the acrylic polymer can be derived from 15% or less by weight of the carboxylic acid anhydride, based on the total weight of monomers in the acrylic polymer (e.g., 12% or less, 10% or less, 9% or less, 8% or less, 7% or less, 6% or less, 5% or less, 4.5% or less, 4% or less, 3.5% or less, 3% or less, 2.5% or less, 2% or less, 1.5% or less, 1% or less, 0.75% or less, or 0.5% or less). The amount of carboxylic acid anhydride the acrylic polymer is derived from can range from any of the minimum values described above to any of the maximum values described above. For example, the acrylic polymer can be derived from greater than 0% to 15% by weight carboxylic acid anhydride, based on the total weight of monomers in the acrylic polymer (e.g., from greater than 0% to 10%, from 1% to 10%, from 1% to 8%, from 1.5% to 10%, from 1.5% to 6%, or from 1.5% to 5%).

In general, the acrylic copolymer described herein can, for example, include from greater than 0% such as 0.05% or more by weight of the aminosilane (including aminosilane covalently bonded to as well as not bonded to the acrylic copolymer), based on the total weight of monomers in the acrylic copolymer. For example, the acrylic copolymer can include 0.1% or more, 0.2% or more, 0.3% or more, 0.4% or more, 0.5% or more, 0.6% or more, 0.7% or more, 0.8% or more, 0.9% or more, 1% or more, 1.1% or more, 1.2% or more, 1.3% or more, 1.4% or more, 1.5% or more, 1.8% or more, 2% or more, 2.5% or more, 3% or more, 3.5% or more, 4% or more, 4.5% or more, 5% or more, 6% or more, 7% or more, 8% or more, 9% or more, 10% or more, 11% or more, or 12% or more aminosilane, based on the total weight of monomers in the acrylic copolymer. In some examples, the acrylic copolymer can include 15% or less by weight of the aminosilane, based on the total weight (e.g., 14% or less, 12% or less, 10% or less, 9% or less, 8% or less, 7% or less, 6% or less, 5.5% or less, 5% or less, 4.5% or less, 4% or less, 3.5% or less, 3% or less, 2.5% or less, 2% or less, 1.5% or less, 1% or less, or 0.5% or less). The amount of the one or more aminosilanes in the acrylic copolymer can range from any of the minimum values described above to any of the maximum values described above. For example, the acrylic copolymer can include from greater than 0% to 15% by weight of the one or more aminosilanes, based on the total weight of monomers in the acrylic copolymer (e.g., from 0.05% to 15%, from 1% to 12%, from 1% to 10%, from 1.5% to 8%, from 1.5% to 6%, or from 1.5% to 4%).

In some examples, the acrylic copolymer in the hybrid curable compositions include a hydroxy functional monomer. For example, the acrylic copolymer can be derived from monomers including one or more (meth)acrylate monomers and one or more hydroxy functional monomer. In some examples, the hydroxy functional monomer can include hydroxyethyl acrylate, hydroxypropyl acrylate, hydroxy methylethyl acrylate, hydroxyethyl acrylamide, hydroxybutyl acrylate, hydroxyethyl methacrylate, hydroxyethyl methacrylate, hydroxypropyl methacrylate, glycerol monomethacrylate, hydroxypropyl)methacrylamide, or a combination thereof. In some examples, the hydroxy functional monomer consists of hydroxyethyl methacrylate.

The acrylic copolymer can be derived from greater than 0% such as 0.05% or more by weight of the hydroxy functional monomer, based on the total weight of monomers in the acrylic copolymer. In certain embodiments, the acrylic copolymer can be derived from 0.1% or more, 0.2% or more, 0.3% or more, 0.4% or more, 0.5% or more, 0.6% or more, 0.7% or more, 0.8% or more, 0.9% or more, 1% or more, 1.1% or more, 1.2% or more, 1.3% or more, 1.4% or more, 1.5% or more, 1.8% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, 9% or more, 10% or more, 11% or more, 12% or more, 14% or more, 15% or more, 17% or more, 18% or more, 20% or more, 22% or more, 25% or more, 28% or more, or up to 30% or more hydroxy functional monomer, based on the total weight of monomers in the acrylic copolymer. In some examples, the acrylic copolymer can be derived from 30% or less by weight of the hydroxy functional monomer, based on the total weight of monomers in the acrylic copolymer (e.g., 25% or less, 22% or less, 20% or less, 18% or less, 15% or less, 13% or less, 12% or less, 10% or less, 9% or less, 8% or less, 7% or less, 6% or less, 5.5% or less, 5% or less, 4.5% or less, 4% or less, 3.5% or less, 3% or less, 2.5% or less, 2% or less, or 1.5% or less). The amount of hydroxy functional monomer the acrylic copolymer is derived from can range from any of the minimum values described above to any of the maximum values described above. For example, the acrylic copolymer can be derived from greater than 0% to 30% by weight of the hydroxy functional monomer, based on the total weight of monomers in the acrylic copolymer (e.g., from 1% to 20%, from 1% to 15%, from 3% to 15%, or from 3% to 12%).

The acrylic copolymer further includes one or more (meth)acrylate monomers. The term “(meth)acrylate monomer” as used herein includes acrylate, methacrylate, diacrylate, and dimethacrylate monomers. The (meth)acrylate monomer can include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C₁-C₂₀, C₄-C₂₀, C₁-C₁₆, or C₄-C₁₆ alkanols).

Examples of (meth)acrylate monomers can include, but are not limited to, n-butyl (meth)acrylate, 2-ethylhexyl (meth)acrylate, methyl (meth)acrylate, ethyl (meth)acrylate, iso-butyl (meth)acrylate, tert-butyl (meth)acrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, heptadecyl (meth)acrylate, lauryl (meth)acrylate, tridecyl (meth)acrylate, stearyl (meth)acrylate, glycidyl (meth)acrylate, allyl (meth)acrylate, tetrahydrofurfuryl (meth)acrylate, cyclohexyl (meth)acrylate, 2-propylheptyl (meth)acrylate, behenyl (meth)acrylate, cyclohexyl methacrylate, t-butyl acrylate, t-butyl methacrylate, stearyl methacrylate, behenyl methacrylate, allyl methacrylate, ethyldiglycol acrylate, iso-4-hydroxylbutyl acrylate, hydroxyethylcaprolactone acrylate, 2-ethoxyethyl acrylate, 2-methoxyethyl acrylate, and combinations thereof. In some examples, the (meth)acrylate monomer comprises butyl (meth)acrylate, ethyl (meth)acrylate, 2-ethylhexyl (meth)acrylate, or a combination thereof. For example, the (meth)acrylate monomer comprises butyl acrylate, ethyl acrylate, methyl methacrylate, 2-ethylhexyl acrylate, or a combination thereof. In some examples, the one or more of the (meth)acrylate monomers when homopolymerized can have a measured T_{g} of −10° C. or less, such as 0° C. or less, from −10° C. to −60° C., or from 0° C. to −60° C. as measured using differential scanning calorimetry (DSC) using the mid-point temperature using the method described, for example, in ASTM 3418/82. In some examples, the acrylic copolymer can include at least one monomer selected from the group consisting of butyl acrylate, ethyl acrylate, 2-ethylhexyl acrylate, methyl methacrylate, and combinations thereof.

The acrylic copolymer can, for example, be derived from 45% or more by weight of the (meth)acrylate monomer, (e.g., 50% or more, 55% or more, 60% or more, 65% or more, 70% or more, 75% or more, 80% or more, 85% or more, 90% or more, or 95% or more), based on the total monomer content. In some examples, the acrylic copolymer can be derived form 95% or less by weight of the (meth)acrylate monomer, (e.g., 90% or less, 85% or less, 80% or less, 75% or less, 70% or less, 65% or less, 60% or less, 55% or less, or 50% or less), based on the total monomer weight. The amount of the (meth)acrylate monomer in the acrylic copolymer can range from any of the minimum values described above to any of the maximum values described above. For example, the acrylic copolymer can be derived from 45% to 95% by weight of the (meth)acrylate monomer, (e.g., from 50% to 95%, from 60% to 95%, from 75% to 95%, or from 75% to 90%), based on the total monomer content.

In some embodiments, the acrylic copolymer can include further monomers such as a multivinyl siloxane oligomer. Multivinyl siloxane oligomers are described in U.S. Pat. No. 8,906,997, which is hereby incorporated by reference in its entirety. The multivinyl siloxane oligomer can include oligomers having a Si—O—Si backbone. For example, the multivinyl siloxane oligomer can have a structure represented by the formula

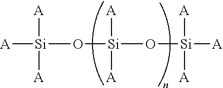

wherein each of the A groups are independently selected from hydrogen, hydroxy, alkoxy, substituted or unsubstituted C₁₋₄ alkyl, or substituted or unsubstituted C₂₋₄ alkenyl and n is an integer from 1 to 50 (e.g., 10). As used herein, the terms “alkyl” and “alkenyl” include straight- and branched-chain monovalent substituents. Examples include methyl, ethyl, propyl, butyl, isobutyl, vinyl, allyl, and the like. The term “alkoxy” includes alkyl groups attached to the molecule through an oxygen atom. Examples include methoxy, ethoxy, and isopropoxy.

In some embodiments, at least one of the A groups in the repeating portion of multivinyl siloxane are vinyl groups. The presence of multiple vinyl groups in the multivinyl siloxane oligomers enables the oligomer molecules to act as crosslinkers in compositions comprising the copolymers. In some examples, the multivinyl siloxane oligomer can have the following structure represented by the formula:

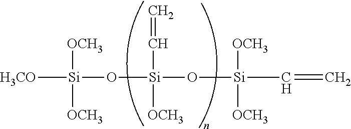

wherein n is an integer from 1 to 50 (e.g., 10). Further examples of suitable multivinyl siloxane oligomers include DYNASYLAN 6490, a multivinyl siloxane oligomer derived from vinyltrimethoxysilane, and DYNASYLAN 6498, a multivinyl siloxane oligomer derived from vinyltriethoxysilane, both commercially available from Evonik Degussa GmbH (Essen, Germany). Other suitable multivinyl siloxane oligomers include VMM-010, a vinylmethoxysiloxane homopolymer, and VEE-005, a vinylethoxysiloxane homopolymer, both commercially available from Gelest, Inc. (Morrisville, Pa.).

The acrylic copolymer can be further derived from an acid monomer. The acid monomer can include a carboxylic acid-containing monomer. Examples of carboxylic acid-containing monomers include α,β-monoethylenically unsaturated mono- and dicarboxylic acids. In some embodiments, the one or more carboxylic acid-containing monomers can be selected from the group consisting of acrylic acid, methacrylic acid, itaconic acid, maleic acid, fumaric acid, crotonic acid, dimethacrylic acid, ethylacrylic acid, allylacetic acid, vinylacetic acid, mesaconic acid, methylenemalonic acid, styrene carboxylic acid, citraconic acid, and combinations thereof.

The acrylic copolymer can be derived from 10% or less (e.g., 9% or less, 8% or less, 7% or less, 6% or less, 5% or less, 4.5% or less, 4% or less, 3.5% or less, 3% or less, 2.5% or less, 2% or less, 1.5% or less, or 1% or less) by weight of acid-containing monomers, based on the total weight of monomers from which the acrylic copolymer is derived. In some embodiments, the acrylic copolymer can be derived from 0% or greater (e.g., 0.1% or greater, 0.3% or greater, 0.5% or greater, or 1% or greater) by weight of acid-containing monomers, based on the total weight of monomers from which the acrylic copolymer is derived. In certain embodiments, the acrylic copolymer can be derived from 0% to 5% by weight, from 0.1% to 4% by weight, from 0.5% by weight to 4% by weight or from 0.5% by weight to 3.5% by weight of one or more acid-containing monomers, based on the total weight of monomers from which the acrylic copolymer is derived.

The acrylic copolymer can be derived from other monomers. For example, the acrylic copolymer can be derived from vinyl aromatic monomers, vinyl esters of branched mono-carboxylic acids having a total of 2 to 12 carbon atoms in the acid residue moiety and 4 to 14 total carbon atoms such as, vinyl acetate, vinyl 2-ethylhexanoate, vinyl neo-nonanoate, vinyl neo-decanoate, vinyl neo-undecanoate, vinyl neo-dodecanoate and mixtures thereof, diene monomer such as 1,2-butadiene, 1,3-butadiene, 2-methyl-1,3-butadiene, 2-chloro-1,3-butadiene, and isoprene) and copolymerizable surfactant monomers (e.g., those sold under the trademark ADEKA REASOAP).

Suitable vinyl aromatic monomers for use in the copolymers can include styrene or an alkyl styrene such as α- and p-methylstyrene, α-butylstyrene, p-n-butylstyrene, p-n-decylstyrene, vinyltoluene, and combinations thereof. The vinyl aromatic monomer can be present in an amount of 0% by weight or greater (e.g., 1% by weight or greater, 2% by weight or greater, 5% by weight or greater, 10% by weight or greater, 15% by weight or greater, 20% by weight or greater, or 25% by weight or greater), based on the total weight of monomers from which the acrylic copolymer is derived. In some embodiments, vinyl aromatic monomer can be present in the acrylic copolymer in an amount of 50% by weight or less (e.g., 45% by weight or less, 40% by weight or less, 35% by weight or less, 30% by weight or less, 25% by weight or less, 15% by weight or less, or 10% by weight or less) based on the total weight of monomers from which the acrylic copolymer is derived. The acrylic copolymer can be derived from any of the minimum values to any of the maximum values by weight described above of the vinyl aromatic monomer. For example, the acrylic copolymer can be derived from 0% to 50% by weight (e.g., from 0% to 45%, from 2% to 40%, from 5% to 35%, from 0% to 15%, from 0% to 10%, from 2% to 10%, or from 0% to 5% by weight of vinyl aromatic monomer), based on the total weight of monomers from which the acrylic copolymer is derived.

In some embodiments, the acrylic copolymer includes a (meth)acrylamide or a derivative thereof. The (meth)acrylamide derivative include, for example, keto-containing amide functional monomers defined by the general Formula VI below

CH₂═CR₁C(O)NR₂C(O)R₃ (VI)

wherein R₁ is hydrogen or methyl; R₂ is hydrogen, a C₁-C₄ alkyl group, or a phenyl group; and R₃ is hydrogen, a C₁-C₄ alkyl group, or a phenyl group. For example, the (meth)acrylamide derivative can be diacetone acrylamide (DAAM). Suitable acetoacetoxy monomers that can be included in the acrylic copolymer include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Sulfur-containing monomers that can be included in the acrylic copolymer including, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. Examples of suitable phosphorus-containing monomers that can be included in the acrylic copolymer include dihydrogen phosphate esters of alcohols in which the alcohol contains a polymerizable vinyl or olefenic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, H₂C═C(CH₃)COO(CH₂CH₂O)ₙP(O)(OH)₂, and analogous propylene and butylene oxide condensates, where n is an amount of 1 to 50, phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2-methylpropanephosphinic acid, 2-acrylamido-2-methyl propane sulfonic acid or a salt thereof (such as sodium, ammonium, or potassium salts), α-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof. In some embodiments, the acrylic copolymer includes 2-acrylamido-2-methyl propane sulfonic acid.

Hydroxy (meth)acrylates that can be included in the acrylic copolymer include, for example, hydroxyl functional monomers defined by the general Formula VII below

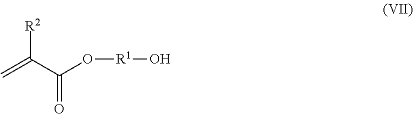

wherein R¹ is hydrogen or methyl and R₂ is hydrogen, a C₁-C₄ alkyl group, or a phenyl group. For example, the hydroxyl (meth)acrylate can include hydroxypropyl (meth)acrylate, hydroxybutylacrylate, hydroxybutylmethacrylate, hydroxyethylacrylate (HEA) and hydroxyethylmethacrylate (HEMA).

Other suitable additional monomers that can be included in the acrylic copolymer include (meth)acrylonitrile, vinyl halides, vinyl ethers of an alcohol comprising 1 to 10 carbon atoms, aliphatic hydrocarbons having 2 to 8 carbon atoms and one or two double bonds, phosphorus-containing monomers, acetoacetoxy monomers, sulfur-based monomers, hydroxyl (meth)acrylate monomers, methyl (meth)acrylate, ethyl (meth)acrylate, alkyl crotonates, di-n-butyl maleate, di-octylmaleate, acetoacetoxyethyl (meth)acrylate, acetoacetoxypropyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2 ethoxyethoxy)ethyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, or combinations thereof.

When present, the one or more additional monomers can be present in small amounts (e.g., 10% by weight or less, 7.5% by weight or less, 5% by weight or less, 4% by weight or less, 3% by weight or less, 2% by weight or less, 1.5% by weight or less, 1% by weight or less, or 0.5% by weight or less), based on the total weight of monomers from which the acrylic copolymer is derived. The one or more additional monomers when present can be present in an amount of greater than 0%, 0.1% by weight or greater, 0.3% or greater, 0.5% or greater, 0.75% or greater, or 1% or greater by weight, based on the total weight of monomers from which the acrylic copolymer is derived.

In some embodiments, the monomers in the acrylic copolymer can be polymerized in the presence of a chain transfer agent. A “chain transfer agent” as used herein refers to chemical compounds that are useful for controlling the molecular weights of polymers, for reducing gelation when polymerizations and copolymerizations involving diene monomers are conducted, and/or for preparing polymers and acrylic copolymers with useful chemical functionality at their chain ends. The chain transfer agent reacts with a growing polymer radical, causing the growing chain to terminate while creating a new reactive species capable of initiating polymerization. The phrase “chain transfer agent” is used interchangeably with the phrase “molecular weight regulator.”

Suitable chain transfer agents for use during polymerization of the acrylic copolymers disclosed herein can include compounds having a carbon-halogen bond, a sulfur-hydrogen bond, a silicon-hydrogen bond, or a sulfur-sulfur bond; an allyl alcohol, or an aldehyde. In some embodiments, the chain transfer agents contain a sulfur-hydrogen bond, and are known as mercaptans. In some embodiments, the chain transfer agent can include C₃-C₂₀ mercaptans. Specific examples of the chain transfer agent can include octyl mercaptan such as n-octyl mercaptan and t-octyl mercaptan, decyl mercaptan, tetradecyl mercaptan, hexadecyl mercaptan, dodecyl mercaptan such as n-dodecyl mercaptan and t-dodecyl mercaptan, tert-butyl mercaptan, mercaptoethanol such as β-mercaptoethanol, 3-mercaptopropanol, mercaptopropyltrimethoxysilane, tert-nonyl mercaptan, tert-dodecyl mercaptan, 6-mercaptomethyl-2-methyl-2-octanol, 4-mercapto-3-methyl-1-butanol, methyl-3-mercaptopropionate, butyl-3-mercaptopropionate, i-octyl-3-mercaptopropionate, i-decyl-3-mercaptopropionate, dodecyl-3-mercaptopropionate, octadecyl-3-mercaptopropionate, and 2-phenyl-1-mercapto-2-ethanol. Other suitable examples of chain transfer agents that can be used during polymerization of the acrylic copolymers include thioglycolic acid, methyl thioglycolate, n-butyl thioglycolate, i-octyl thioglycolate, dodecyl thioglycolate, octadecyl thioglycolate, ethylacrylic esters, terpinolene. In some examples, the chain transfer agent can include tert-dodecyl mercaptan.

In some embodiments, the monomers in the acrylic copolymer are polymerized in the absence of a chain transfer agent.

When used, the amount of chain transfer agent utilized during polymerization can be present in an amount of at least 1 part by weight per hundred monomers present in the acrylic copolymer. For example, the chain transfer agent can be present in an amount of from 1 part to 4 parts, from 1.5 parts to 4 parts, from 1 part to 3.5 parts, from 1.5 parts to 3.5 parts, from 1 part to 3 parts, from 1.5 parts to 3 parts, or from 1 part to 2.5 parts by weight per hundred monomers present in the acrylic copolymer during polymerization. When the chain transfer agent is used, the resulting acrylic copolymer can contain from about 0.01% to about 4%, from about 0.05% to about 4%, from about 0.1% to about 4%, or from about 0.1% to about 3.5% by weight of the chain transfer agent.

The acrylic copolymers described herein can have a theoretical glass-transition temperature (Tg) and/or a Tg as measured by differential scanning calorimetry (DSC) using the mid-point temperature using the method described, for example, in ASTM 3418/82, of 40° C. or less (e.g., 35° C. or less, 30° C. or less, 25° C. or less, 20° C. or less, 15° C. or less, 12° C. or less, 10° C. or less, 8° C. or less, 5° C. or less, 3° C. or less, 1° C. or less, 0° C. or less, −3° C. or less, −5° C. or less, −10° C. or less, −15° C. or less, −20° C. or less, −25° C. or less, −30° C. or less, −35° C. or less, or −40° C. or less). The acrylic copolymers can have a theoretical Tg and/or a Tg as measured by DSC using the mid-point temperature using the method described, for example, in ASTM 3418/82, of −70° C. or greater (e.g., −65° C. or greater, −60° C. or greater, −55° C. or greater, −50° C. or greater, −45° C. or greater, −40° C. or greater, −35° C. or greater, −30° C. or greater, −25° C. or greater, −20° C. or greater, −15° C. or greater, −10° C. or greater, −5° C. or greater, 0° C. or greater, 5° C. or greater, 10° C. or greater, 15° C. or greater, 20° C. or greater, 25° C. or greater, 30° C. or greater, 35° C. or greater, or 40° C. or greater). The acrylic copolymers can have a theoretical Tg and/or a Tg as measured by DSC using the mid-point temperature using the method described, for example, in ASTM 3418/82, ranging from any of the minimum values described above to any of the maximum values described above. For example, the acrylic copolymers can have a theoretical glass-transition temperature (Tg) and/or a Tg as measured by differential scanning calorimetry (DSC) using the mid-point temperature using the method described, for example, in ASTM 3418/82, of from −70° C. to 40° C. (e.g., from −70° C. to 15° C., from −70° C. to 0° C., from −70° C. to less than 0° C., from −60° C. to 40° C., from −60° C. to 35° C., from −60° C. to 25° C., from −60° C. to 10° C., from −60° C. to 0° C., from −60° C. to less than 0° C., from −50° C. to 40° C., from −50° C. to 25° C., from −50° C. to 10° C., from −50° C. to 0° C., from −35° C. to 40° C., from −35° C. to 25° C., from −35° C. to 10° C., or from −35° C. to 0° C.). The theoretical glass transition temperature or “theoretical T_{g}” of the acrylic copolymer refers to the estimated T_{g} calculated using the Fox equation. The Fox equation can be used to estimate the glass transition temperature of a polymer or copolymer as described, for example, in L. H. Sperling, “Introduction to Physical Polymer Science”, 2^{nd} Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of an acrylic copolymer derived from monomers a, b, . . . , and i can be calculated according to the equation below

$$\frac{1}{{T}_{g}} = \frac{{w}_{a}}{{T}_{ga}} + \frac{{w}_{b}}{{T}_{gb}} + … + \frac{{w}_{i}}{{T}_{gi}}$$

where wₐ is the weight fraction of monomer a in the copolymer, T_{ga} us the glass transition temperature of a homopolymer of monomer a, w_{b} is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

The weight average molecular weight of the acrylic copolymers can be less than 50,000 Da. In some embodiments, the weight average molecular weight of the acrylic copolymers can be 25,000 Da or less (e.g., 20,000 Da or less, 15,000 Da or less, 14,000 Da or less, 12,000 Da or less, 10,000 Da or less, 9,000 Da or less, 8,000 Da or less, 7,000 Da or less, 6,000 Da or less, 5,000 Da or less, 4,000 Da or less, 3,000 Da or less, or 2,000 Da or less, or 1,500 Da or less). In some embodiments, the weight average molecular weight of the acrylic copolymers can be from 1,000 Da to 25,000 Da, from 1,000 Da to 15,000 Da, from 2,000 Da to 15,000 Da, from 1,500 Da to 13,000 Da, from 2,500 Da to 13,000 Da, or from 4,000 Da to 13,000 Da.

Functional Silicone

The hybrid curable compositions disclosed herein further include a functional silicone polymer. The functional silicone polymer can react directly or via a crosslinking agent with the acrylic copolymer to form a silicone-acrylic copolymer. The silicone-acrylic copolymer can comprise a covalently bonded silicone polymer and the acrylic copolymer through —Si—O—Si— linkage.

The functional silicone polymer can include a reactive functional group, such as a hydroxyl functional group, an amine functional group, a thiol functional group, an alkoxy functional group, a hydride functional group, a vinyl functional group, or a mixture thereof. In some embodiments, the functional silicone polymer is end-capped with the functional group. For example, the silicone polymer can be end-capped with the hydroxyl, alkoxyl, hydride, or vinyl functional group. Preferably, the functional silicone polymer includes a hydroxyl functional group. In certain embodiments, the functional silicone polymer includes a non-hydroxy-terminated functional silicone polymer or a mixture of hydroxy-terminated and non-hydroxy-terminated functional silicone polymers.

In some embodiments, the functional silicone polymer can include a polysiloxane backbone. The polysiloxane can include an organo-containing substituent such as an alkyl substituent. For example, the polysiloxane can include a dimethyl, methylvinyl, methylphenyl, diphenyl, methylethyl, or 3,3,3-trifluoropropyl substituent. Preferably, the functional silicone polymer includes a polydialkylsiloxane backbone, more preferably a polydimethylsiloxane backbone.

The functional silicone polymer can include a polysiloxane having a structure according to the formula:

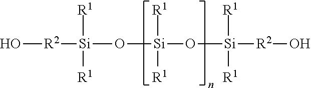

wherein R¹, independently for each occurrence, is independently selected from alkyl, alkenyl, alkynyl, aryl, arylalkyl, heteroaryl, heteroarylalkyl, cycloalkyl, cycloalkylalkyl, heterocyclyl, and heterocyclylalkyl; R², independently for each occurrence, is independently selected from alkyl, aryl, arylalkyl and a bond; and n ranges from 10 to 1,000, from 50 to 800, from 100 to 500, or from 150-250, wherein the alkyl, alkenyl, alkynyl, aryl, arylalkyl, heteroaryl, heteroarylalkyl, cycloalkyl, cycloalkylalkyl, heterocyclyl, and heterocyclylalkyl are each independently, at each occurrence, unsubstituted or substituted with one or more suitable substituents. In some embodiments, R¹, independently for each occurrence, is independently selected from C₁ to C₄₀ alkyl, C₂ to C₄₀ alkenyl, C₂ to C₄₀ alkynyl, C₆ to C₄₀ aryl, C₃ to C₄₀ heteroaryl. In some embodiments, R¹, independently for each occurrence, is independently selected from C₁ to C₁₀ alkyl, C₂ to C₁₀ alkenyl, or C₂ to C₁₀ alkynyl. In some embodiments, R², independently for each occurrence, is independently selected from C₁ to Cao alkyl or a bond. In some embodiments, R², independently for each occurrence, is independently selected from C₁ to C₁₀ alkyl or a bond. In some example, R¹ is methyl at each occurrence. In certain embodiments, R¹ is methyl at each occurrence and R² is a bond at each occurrence. In certain embodiments, the polysiloxane is a hydroxy-terminated polydimethylsiloxane having formula:

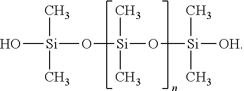

In certain embodiments, the functional silicone polymer such as a polysiloxane can have a weight average molecular weight of 3,000,000 Da or less (e.g., 2,000,000 Da or less, from 10,000 Da to 2,000,000 Da, or from 500,000 Da to 2,000,000 Da.

In certain embodiments, the functional silicone polymer has a viscosity of at least 100 cps), such as at 10,000 cps or more, from 100 cps to 2,000.000 cps, from 100 cps to 1,000,000 cps, or from 100 cps to 100,000 cps.

Crosslinker

The hybrid curable compositions disclosed herein also include a crosslinking agent. The crosslinking agent can include a silane crosslinking agent. The silane crosslinking agent can include an oxime silane crosslinker, an acetoxy silane crosslinker, an oximino silane based crosslinker, a methylethylketoxime (MEKO) based crosslinker, a methylisobutylketoxime (MIBKO) based crosslinker, an acetoxime based crosslinker, an alkoxy silane based crosslinker, or a combination thereof. In some embodiments, the silane crosslinking agent can be selected from one or more of methyltris(methylethylketoxime) silane, methyltris(acetoxime)silane, methyltris(methylisobutylketoxime) silane, dimethyldi(methylethylketoxime)silane, trimethyl(methyl ethylketoxime)silane, tetra(methylethylketoxime)silane, tetra(methylisobutylketoxime)silane, vinyltris(methylethyl ketoxime)silane, methylvinyldi(methylethylketoxime)silane, methylvinyldi(cyclohexanoneoxime)silane, vinyltris(methyl isobutylketoxime)silane, phenyltris(methylethylketoxime) silane, methylisobutylketoxime (MIBKO), vinyl tris(acetoxime)silane, or acetoxime (dimethylketoxime). In some examples, the crosslinking silane can include a vinyl oximino silane, a methyl oximino silane, or a mixture thereof. For example, the crosslinking agent can include methyltri(oxime)silanes and vinyltri(oxime) silanes.

The crosslinking silane can aid in curing the compositions disclosed herein. Preferably the silane crosslinker chemically crosslinks the functional silicone polymer and the acrylic copolymer when curing the composition. This has the advantage that the composition is stable on storage, and during application, so as to remain either sprayable or spreadable.

Moisture Cure Catalysts

The hybrid curable compositions described herein can be cured via a moisture curing mechanism. In some examples, the compositions include a moisture curing catalyst. Moisture curing catalysts are known from the literature, for example G. Oertel (ed.), Polyurethane, 3^{rd} edition 1993, Carl Hanser Verlag, Munich—Wien, pages 104 to 110, section 3.4.1. Further metal catalysts are described by Blank et al. described in Progress in Organic Coatings, 1999, Vol. 35, pages 19-29. The catalyst may promote crosslinking reaction through hydrolysis condensation reaction.

In some embodiments, the moisture cure catalyst includes a Lewis acid catalyst, such as, a metal carboxylate, a metal alkoxide, or a mixture thereof. Preferably, the catalysts are tin-free catalysts. Preferably, the catalysts are also free of a scrambling catalyst. Scrambling catalysts may have a pKa value equal to or less than −6 or equal to or greater than 15. Scrambling catalysts include KOH, NaOH, LiOH, organolithium reagents, Grignard reagents, methanesulfonic acid, sulfuric acid, acidic clay, acidic ion exchange resins, and mixtures thereof.

In some examples, the moisture cure catalyst includes metal complexes such as acetylacetonates of iron, titanium, aluminum, zirconium, manganese, nickel, zinc and cobalt. For example, the catalyst can include zirconium compounds such as zirconium tetraacetylacetonate (e.g., K-KAT™ 4205; K-KAT™ 5218, K-KAT™ XC 9213, XC-A 209, and XC-6212 from King Industries); bismuth compounds, in particular tricarboxylic carboxylates (e.g., K-KAT™ 348, XC-B221; XC-C227, XC 8203 from King Industries). Tin and zinc-free catalysts from Borchers, available under the trade name Borchi® Cat can also be used. For example, the moisture cure catalyst can include BORCHI® KAT 24. Cesium salts can also be used as catalysts. Examples of tin compounds include tin (II) salts of organic carboxylic acids, for example tin (II) diacetate, tin (II) bis(ethylhexanoate), tin (II) dilaurate, dialkyltin (IV) salts of organic carboxylic acids, for example, dimethyltin diacetate, dibutyltin diacetate, dibutyltin dibutyrate, dibutyltin bis dilaurate (2-ethylhexanoate), dibutyltin, dibutyltin maleate, dioctyltin dilaurate and dioctyltin diacetate. In addition, zinc (II) salts can be used, such as zinc (II) diactetate. Preferably, the moisture cure catalyst is free of tin.

Other examples of suitable catalysts can include amine-based catalysts. Examples of amine-based catalysts include aliphatic primary amines such as methylamine, ethylamine, propylamine, isopropylamine, butylamine, amylamine, hexylamine, octylamine, 2-ethylhexylamine, nonylamine, decylamine, laurylamine, pentadecylamine, cetylamine, stearylamine, and cyclohexylamine; aliphatic secondary amines such as dimethylamine, diethylamine, dipropylamine, diisopropylamine, dibutylamine, diamylamine, dihexylamine, dioctylamine, di(2-ethylhexyl)amine, didecylamine, dilaurylamine, dicetylamine, distearylamine, methylstearylamine, ethylstearylamine, and butylstearylamine; aliphatic tertiary amines such as triamylamine, trihexylamine, and trioctylamine; aliphatic unsaturated amines such as triallylamine and oleylamine; aromatic amines such as aniline, laurylaniline, stearylaniline, and triphenylamine; nitrogen-containing heterocyclic compounds such as pyridine, 2-aminopyridine, 2-(dimethylamino)pyridine, 4-(dimethylamino pyridine), 2-hydroxypyridine, imidazole, 2-ethyl-4-methylimidazole, morpholine, N-methylmorpholine, piperidine, 2-piperidinemethanol, 2-(2-piperidino)ethanol, piperidone, 1,2-dimethyl-1,4,5,6-tetrahydropyrimidine, 1,8-diazabicyclo(5,4,0)undecene-7 (DBU), 6-(dibutylamino)-1,8-diazabicyclo(5,4,0)undecene-7 (DBA-DBU), 1,5-diazabicyclo(4,3,0)nonene-5 (DBN), 1,4-diazabicyclo(2,2,2)octane (DABCO), and aziridine; and other amines such as monoethanolamine, diethanolamine, triethanolamine, 3-hydroxypropylamine, ethylenediamine, propylenediamine, hexamethylenediamine, N-methyl-1,3-propanediamine, N,N′-dimethyl-1,3-propanediamine, diethylenetriamine, triethylenetetramine, 2-(2-aminoethylamino)ethanol, benzylamine, 3-methoxypropylamine, 3-lauryloxypropylamine, 3-dimethylaminopropylamine, 3-diethylaminopropylamine, 3-dibutylaminopropylamine, 3-morpholinopropylamine, 2-(1-piperazinyl)ethylamine, xylylenediamine, and 2,4,6-tris(dimethylaminomethyl)phenol; guanidines such as guanidine, phenylguanidine, and diphenylguanidine; and biguanides such as butylbiguanide, 1-o-tolylbiguanide, and 1-phenylbiguanide.

Amidines such as 1,2-dimethyl-1,4,5,6-tetrahydropyrimidine, DBU, DBA-DBU, and DBN; guanidines such as guanidine, phenylguanidine, and diphenylguanidine; and biguanides such as butylbiguanide, 1-o-tolylbiguanide, and 1-phenylbiguanide have high catalytic activity. High adhesion for aryl-substituted biguanides such as 1-o-tolylbiguanide and 1-phenylbiguanide can be expected. Amine compounds whose conjugate acids have a pKa of 11 or higher have high catalytic activity. Amine compounds such as 1,2-dimethyl-1,4,5,6-tetrahydropyrimidine, DBU, and DBN have high catalytic activity because their conjugate acids have a pKa of 12 or higher. The moisture cure catalysts can be present in an amount of from 0% (or greater than 0%) to 20% by weight, from 0% (or greater than 0%) to 10% by weight, or from greater than 0% to 5% by weight, based on the weight of the composition.

Hybrid Moisture Curable Compositions

The hybrid moisture curable compositions comprising an acrylic copolymer, a functional silicone, a crosslinker, and a moisture cure catalyst can be used in a wide range of applications that can use curable compositions. As described herein, the compositions are formulated to cure by crosslinking when exposed to moisture in the environment. In some examples, the hybrid moisture curable compositions can be used in curable applications including adhesives, potting compounds, caulks, mold making, sealing compositions for structures, boats and ships, automobiles, roads and the like, blocking agents, insulation, vibration dampers, acoustic insulation, foamed materials, paints, spraying materials, waterproofing compositions, coatings in sanitary rooms, glazing, prototyping, joint seals between different materials, e.g. sealants between ceramic or mineral surfaces and thermoplastics, paper releases, impregnants, and the like. Furthermore, the hybrid moisture curable compositions composition when used, for example, as a coating or adhesive, can adhere onto a broad variety of substrates including organic, inorganic, or composite substrates. Such substrates include synthetic and natural polymers, wood, metal, glass, mineral substrates such as concrete, rubber or plastic, plaster, brick, stone, and ceramic. The substrate can be a coated surface, comprising a silicone coating or an acrylic coating. The hybrid moisture curable compositions can further include one or more additives such as one or more on enhancers (also referred to as adhesion promoters), coalescing aids/agents (coalescents), film forming aids (i.e., plasticizers), water scavengers, defoamers, fillers, pigments, thickeners, biocides, crosslinking agents, flame retardants, stabilizers, moisture cure catalysts, and corrosion inhibitors. In some embodiments, the hybrid moisture curable compositions do not include (is free of) water scavengers. The hybrid moisture curable compositions can have a Brookfield viscosity of 25,000 cps or greater, from 25,000 cps to 100,000 cps, or from 25,000 cps to 60,000 cps, determined at 25° C. and 20 rpm using a #7 spindle. The compositions can have a solids weight % of 80% or greater, from 50% to 99%, or from 80% to 99%.

In some embodiments, the hybrid moisture curable compositions can be used in coating formulations, for example, in roof coating formulations. The compositions can be applied to a wide variety of weathered and unweathered roofing substrates, such as, for example, asphaltic coatings, roofing felts, synthetic polymer membranes, foamed polyurethane (e.g., spray polyurethane foam), metals (e.g., aluminum), modified bitumen membranes; or to previously painted, primed, undercoated, worn, or weathered substrates, such as metal roofs weathered thermoplastic polyolefin, weathered poly(vinyl chloride), weathered silicone rubber, and weathered ethylene propylene diene monomer rubber.

In some embodiments, the hybrid moisture curable compositions can be used in for example, adhesive formulations. The adhesives formulations can include flooring adhesives, pressure-sensitive adhesives, elastic adhesives, contact-type adhesives, tiling adhesives, powder coating, medical adhesives, adhesives for interior panels, adhesives for exterior panels, tiling adhesives, stone finishing adhesives, ceiling finishing adhesives, floor finishing adhesives, wall finishing adhesives, vehicle paneling adhesives, and electric or electronic or precision equipment assembly adhesives.

Since the compositions can be closely adhered to a wide range of substrates such as glass, porcelain, wood, metal, resin molded products and the like by itself or with the aid of a primer, the hybrid moisture curable compositions can also be used as various types of tight-sealing compositions. In some embodiments, the hybrid moisture curable compositions can be used in sealant formulations. The sealant formulations can be used for architectural sealings for sealing joints having a wide variety of different materials, for example of stones such as granite and marble, concrete, mineral substrates, porcelain, metals, glass, ceramics, wood, resins, painted surfaces or substrates, and plastics including PVC. The substrate can be a coated surface, comprising a silicone coating or an acrylic coating. The sealant formulations can further include one or more additives such as one or more on enhancers, moisture cure catalysts, film forming aids (i.e., plasticizers), silicone resins, water scavengers, fillers, pigments, thickeners, biocides, flame retardants, and corrosion inhibitors. In some instances, the sealant compositions can include an unreactive plasticizer known in the art and may include silane-crosslinking systems such as phthalic esters, adipic esters, benzoic esters, glycol esters, and esters of saturated alkanediols. Sealant formulations are described in U.S. Pat. Nos. 9,523,002 and 9,920,229 which are incorporated herein by reference in their entirety.

In some embodiments, the hybrid moisture curable compositions can be used in waterproofing formulations. The waterproofing formulations can provide a liquid-applied moisture-permeable waterproofing material that can be applied easily and used, for example, to protect a building from rainwater or humidity in the air and to drain moisture that has been gathered on a substrate of a building. The waterproofing formulations can be used around an opening such as a window or a door. The waterproofing formulations can further include one or more additives such as one or more on enhancers, coalescing aids/agents, plasticizers, water scavengers, fillers, pigments, thickeners, biocides, crosslinking agents, amine compounds, flame retardants, stabilizers, moisture cure catalysts, and corrosion inhibitors. Waterproofing formulations are described in U.S. Pat. No. 9,217,060 which is incorporated herein by reference in its entirety.

In some examples, the waterproofing formulations can be used in roofing applications to provide a durable, breathable, weatherproof barrier that is resistant to rain, snow, sun, wind, air moisture, UV degradation, and natural weathering over a wide temperature range. The compositions may also provide thermal insulation, shock resistance, vibration resistance/noise reduction, electrical insulation, and/or non-slip properties. The composition can include additives such as mineral fillers, carriers or diluents or modifiers, crosslinking agents, catalysts, and colorants.

In the hybrid moisture curable compositions, the acrylic copolymer can be present in an amount of 20% by weight or greater, based on the total amount of polymers in the compositions described herein. For example, the acrylic copolymer can be present in an amount of 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, 70% by weight or greater, 75% by weight or greater, 80% by weight or greater, or up to 90% by weight or greater, based on the total amount of polymers in the hybrid moisture curable composition.

The acrylic copolymer can be present in an amount of 5% by weight or greater, based on the total weight of the hybrid moisture curable composition described herein. For example, the acrylic copolymer can be present in an amount of 10% by weight or greater, 15% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, 70% by weight or greater, 75% by weight or greater, 80% by weight or greater, 85% by weight or greater, or 90% by weight or greater, based on the total weight of the compositions described herein. In some examples, the acrylic copolymer can be present in an amount of from 5% up to 90%, from 5% up to 80%, from 10% to 85%, from 10% to 80%, from 10% to 65%, from 10% to 60%, from 10% to 50%, from 20% to 50%, from 20% to 65%, from 30% to 80%, from 40% to 80%, or from 50% to 80%, by weight of the composition.

In the hybrid moisture curable compositions, the functional silicone polymer can be present in an amount of 20% by weight or greater, based on the total amount of polymers in the compositions described herein. For example, the functional silicone polymer can be present in an amount of 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, 70% by weight or greater, 75% by weight or greater, 80% by weight or greater, or up to 90% by weight or greater, based on the total amount of polymers in the hybrid moisture curable composition.

The functional silicone polymer can be present in an amount of 5% by weight or greater, based on the total weight of the hybrid moisture curable composition described herein. For example, the functional silicone polymer can be present in an amount of 10% by weight or greater, 15% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, 70% by weight or greater, 75% by weight or greater, 80% by weight or greater, 85% by weight or greater, or 90% by weight or greater, based on the total weight of the compositions described herein. In some examples, the functional silicone polymer can be present in an amount of from 5% up to 90%, from 5% up to 80%, from 10% to 85%, from 10% to 80%, from 10% to 65%, from 10% to 60%, from 10% to 50%, from 20% to 50%, from 20% to 65%, from 30% to 80%, from 40% to 80%, or from 50% to 80%, by weight of the composition.

As described herein, the acrylic copolymer and functional silicone polymer can react during curing to form a silicone-acrylic copolymer. The acrylic copolymer and functional silicone polymer can react directly or via the crosslinking agent. The acrylic copolymer and the functional silicone polymer can be present in the curable compositions in a weight ratio of 0.05 or greater, for example, 0.1 or greater, 0.15 or greater, 0.2 or greater, 0.3 or greater, 0.4 or greater, 0.5 or greater, 0.6 or greater, 0.8 or greater, 1 or greater, 1.5 or greater, 2 or greater, 2.5 or greater, 3 or greater, 4 or greater, 5 or greater, 6 or greater, 7 or greater, 8 or greater, 9 or greater, 10 or greater, 12 or greater, 15 or greater, or 20 or greater. The acrylic copolymer and the functional silicone polymer can be present in the curable compositions in a weight ratio of 20 or less, for example, 18 or less, 15 or less, 12 or less, 10 or less, 9 or less, 8 or less, 7 or less, 6 or less, 5 or less, 4 or less, 3 or less, 2 or less, 1 or less, 0.9 or less, 0.8 or less, 0.7 or less, 0.6 or less, 0.5 or less, 0.4 or less, 0.3 or less, 0.2 or less, 0.1 or less, or 0.05 or less. The acrylic copolymer and the functional silicone polymer can be present in the curable compositions in a weight ratio from 1:10 to 10:1, from 1:8 to 8:1, from 1:6 to 6:1, from 1:5 to 5:1, from 1:4 to 4:1, from 1:3 to 3:1, from 1:2 to 2:1, based on the total weight of the composition.

The crosslinker, such as a silane crosslinker can be present in an amount of 0.1% by weight or greater, based on the total weight of the hybrid moisture curable composition described herein. For example, the crosslinker can be present in an amount of 0.2% by weight or greater, 0.4% by weight or greater, 0.5% by weight or greater, 0.6% by weight or greater, 0.8% by weight or greater, 1% by weight or greater, 1.5% by weight or greater, 2% by weight or greater, 2.5% by weight or greater, 3% by weight or greater, 3.5% by weight or greater, 4% by weight or greater, 4.5% by weight or greater, 5% by weight or greater, 5.5% by weight or greater, 6% by weight or greater, 6.5% by weight or greater, 7% by weight or greater, 7.5% by weight or greater, 8% by weight or greater, 8.5% by weight or greater, or up to 10% by weight or greater, based on the total weight of the compositions described herein. In some examples, the crosslinker can be present in an amount of from 0.1% up to 10%, from 0.1% to 8%, from 0.1% to 6%, from 0.5% up to 10%, from 0.5% to 6%, from 0.5% to 5%, from 0.5% to 3.5%, from 1% to 10%, from 1% to 8%, from 1% to 6%, from 1% to 5%, from 1% to 3.5%, from 1.5% to 10%, from 1.5% to 8%, from 1.5% to 6%, from 1.5% to 5%, or from 1.5% to 3.5%, by weight of the composition.

Inorganic Filler

As described herein, the hybrid moisture curable compositions can further include at least one inorganic filler, also referred to herein as pigments or mineral pigments. Examples of suitable inorganic fillers that can be included in the compositions can be selected from TiO₂ (in both anastase and rutile forms), clay (aluminum silicate), CaCO₃ (in both ground and precipitated forms), aluminum oxide, silicon dioxide, magnesium oxide, talc (magnesium silicate), a reinforcing filler (such as silica, preferably fused silica or fumed silica), bentonite, barytes (barium sulfate), zinc oxide, zinc sulfite, sodium oxide, zeolite, potassium oxide and mixtures thereof. Examples of commercially available titanium dioxide pigments are KRONOS® 2101, KRONOS® 2310, available from Kronos WorldWide, Inc., TI-PURE® R-900, available from DuPont, or TIONA® ATi commercially available from Millennium Inorganic Chemicals. Titanium dioxide is also available in concentrated dispersion form. An example of a titanium dioxide dispersion is KRONOS® 4311, also available from Kronos WorldWide, Inc. Suitable pigment blends of metal oxides are sold under the marks MINEX® (oxides of silicon, aluminum, sodium and potassium commercially available from Unimin Specialty Minerals), CELITE® (aluminum oxide and silicon dioxide commercially available from Celite Company), and ATOMITE® (commercially available from Imerys Performance Minerals). Exemplary fillers also include clays such as attapulgite clays and kaolin clays including those sold under the ATTAGEL® and ANSILEX® marks (commercially available from BASF Corporation). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), wollastonite (calcium metasilicate), and combinations thereof. More preferably, the at least one filler includes TiO₂, CaCO₃, and/or a clay.

Generally, the mean particle sizes of the inorganic filler ranges from about 0.01 to about 50 microns. For example, calcium carbonate particles used in the composition can have a median particle size of from about 0.15 to about 10 microns, such as from about 0.5 to about 7 microns or from about 0.5 to about 5 microns. The filler can be added to the composition as a powder or in slurry form.

The inorganic filler can be present in an amount of 0% by weight or greater, based on the total weight of the compositions described herein. For example, the inorganic filler can be present in an amount of 5% by weight or greater, 10% by weight or greater, 15% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, or up to 80% by weight or greater, based on the total weight of the compositions described herein. In some embodiments, the inorganic filler can be present in an amount of from 0% to 80% by weight, such as from greater than 0% to 80% by weight, from 5% to 80% by weight, from 20% to 80% by weight, from 40% to 80% by weight, from 50% to 80% by weight, from 30% to 75% by weight, from 45% to 65% by weight, based on the total weight of the compositions described herein. In some embodiments, the compositions such as adhesive compositions do not include a filler.

In some examples, the compositions can further include at least one organic filler such as polyalkylene fibers, preferably polyethylene fibers.

Adhesion Enhancers

The compositions described herein can include an adhesion enhancer (adhesion promoter). An adhesion enhancer can be added to improve the adhesion of a substrate (such as wood, laminate, or tile) to the surface it is bonded, for example, wood, concrete, metal, metal primer or coating the metal. Adhesion enhancers known to those skilled in the art can be used. Examples of suitable adhesion enhancers for improving adhesion include silane containing compounds, such as organosilanes, aminosilanes, epoxysilanes, amino alkoxy silanes, vinyl alkoxy silanes, isocyanato alkoxy silanes, isocyanurate functional alkoxy silanes, (meth)acrylic silanes, anhydridosilanes or adducts of the aforementioned silanes with primary aminosilanes, aminosilanes or urea silanes, polyamines such as polyethyleneimine, or combinations thereof. Specific examples of adhesion enhancers can include vinyltriethoxysilane, vinyltrimethoxysilane, vinyl tris(2-methoxyethoxysilane), vinyl triisopropoxysilane, (meth)acryloyloxypropyl trimethoxysilane, 7-(meth)acryloxypropyl trimethoxysilane, 7-(meth)acryloxypropyl triethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, or a mixture thereof. In some examples, the organosilane comprises vinyltrimethoxysilane, vinyltriethoxysilane, vinyl tris(2-methoxyethoxysilane), vinyl triisopropoxysilane, gamma-methacryloxypropyltrimethoxy silane, or combinations thereof. For example, the organosilane can comprise vinyltriethoxysilane, gamma-glycidoxypropyltrimethoxysilane, gamma-aminopropyltrimethoxysilane, gamma-isocyanato propyl trimethoxysilane, n-beta-(aminoethyl) gamma-aminopropyl trimethoxysilane, n-(2-aminoethyl)-3-aminopropyl methyl dimethoxysilane, 3-aminopropyl methyl dimethoxy silane, bis-(gamma-trimethoxysilylpropyl amine), n-phenyl-gamma-aminopropyltrimethoxysilane, gamma-isocyanato propyl methyl dimethoxy silane, beta-(3,4-epoxycyclohexyl) ethyl triethoxysilane, gamma-glycidoxypropyltrimethoxysilane, (gamma trimethoxysilylpropyl) isocyanurate, vinyltrimethoxysilane, vinyl triglycidoxyipropylmethylsilane, aminosilanes having a structure represented by Formula I, or a combination thereof. In some embodiments, the adhesion enhancer can include polyamines (i.e., polymers formed from either an amine-group containing monomer or an imine monomer as polymerized units such as aminoalkyl vinyl ether or sulfides; acrylamide or acrylic esters, such as dimethylaminoethyl(meth)acrylate; N-(meth)acryloxyalkyl-oxazolidines such as poly(oxazolidinylethyl methacrylate), N-(meth)acryloxyalkyltetrahydro-1,3-oxazines, and monomers that readily generate amines by hydrolysis). Suitable polyamines can include, for example, poly(oxazolidinylethyl methacrylate), poly(vinylamine), or polyalkyleneimine (e.g., polyethyleneimine).

In some embodiments, the adhesion enhancer comprises a silane group having a reactive moiety reactive with active hydrogen atoms, such as active hydrogen atoms present in the copolymer. Such silanes can include organosilanes such as a mercapto-silane, an amino-trialkoxy silane, or an amino trialkoxysilane.

The adhesion enhancer can be present in an amount sufficient to improve the extent that the common measurement for the purpose of adhesion to a surface for adhesive testing by the failure mode of the bond to the lap shear strength and the substrate. In some embodiments, the amount of the adhesion enhancer present in the hybrid moisture curable compositions can be 0% by weight or greater (e.g., 1% by weight or greater, 2% by weight or greater, 3% by weight or greater, 4% by weight or greater, 5% by weight or greater, 6% by weight or greater, 8% by weight or greater, 10% by weight or greater, 12% by weight or greater, or 15% by weight or greater), based on the total weight of the composition. In some embodiments, the adhesion enhancer can be present in the composition in an amount of 15% by weight or less (e.g., 12% by weight or less, 10% by weight or less, 8% by weight or less, 7% by weight or less, 6% by weight or less, 5% by weight or less, 4% by weight or less, 3% by weight or less, or 2.5% by weight or less) based on the total weight of the adhesive composition. The composition can include any of the minimum values to any of the maximum values by weight described above of the adhesion enhancer. For example, when present, the composition can include from greater than 0% to 15% by weight (e.g., from greater than 0% to 10%, from 1% to 10%, or from greater than 0% to 5% by weight of the adhesion enhancer), based on the total weight of the adhesive composition. Other suitable adhesion enhancers are described in U.S. Pat. No. 9,534,158 which is incorporated herein by reference in its entirety.

Film-Forming Aids

The hybrid moisture curable compositions can further comprise a film forming aid (i.e., a plasticizer). Such materials preferably do not contain water, are miscible with the copolymer, and do not include a reactive group. Suitable film forming aids are known in the art and can include alkyl phthalates, for example, dialkyl phthalates (wherein the alkyl phthalate is mixed C₇, C₉ and C_{II} linear having an alkyl group), carbonyl phthalate, di-iso-dodecyl phthalate, dioctyl phthalate or dibutyl phthalate, diisononyl phthalate, adipates such as dioctyl adipate, azelates and sebacates, polyols such as polyoxyalkylene polyols or polyester polyols, organic phosphoric- and sulfonic acid esters, polybutenes (e.g., polyisobutene), hydrogenated terpenes, trioctyl phosphate, epoxy plasticizers, paraffins (e.g., chloro-paraffins), adipic acid esters, n-methylpyrrolidinone, and naphthenic oils (e.g., alkyl naphthalene). Other suitable plasticizers include diethylene glycol dibenzoate, dipropylene glycol dibenzoate, tripropylene glycol dibenzoate, butyl benzyl phthalate, or a combination thereof. Other suitable plasticizers are described in U.S. Pat. No. 9,534,158 which is incorporated herein by reference in its entirety.

Film forming aids can be added to the compositions to reduce the glass transition temperature (T_{g}) of the compositions below that of the drying temperature to allow for good film formation. The film forming aid can be present in an amount of from 1% to 15%, based on the dry weight of the copolymer. For example, the film forming aid can be present in an amount of from 5% to 15% or from 7% to 15%, based on the dry weight of the copolymer. In some embodiments, the film forming aid can be present in an effective amount to provide compositions having a measured Tg less than ambient temperature (e.g., 20° C.). In some embodiments, the compositions do not include a plasticizer or a film forming aid.

Coalescing Aids

In some embodiments, the compositions can include one or more coalescing aids. Suitable coalescing aids, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether, 2,2,4-trimethyl-1,3-pentanediol monoisobutyrate, or combinations thereof. In some embodiments, the compositions can include one or more coalescing aids such as propylene glycol n-butyl ether and/or dipropylene glycol n-butyl ether.

Water Scavenger

As described herein, the composition can include a water scavenger. Suitable water scavengers can include trimethyl orthoacetate, triethyl orthoacetate, trimethyl orthoformate, triethyl orthoformate, organosilanes such as vinyltrimethoxysilane and vinyltriethoxysilane, α-functional silanes such as N-(silylmethyl)-O-methyl-carbamates, in particular N-(methyldiethoxysilylmethyl)-O-methyl-carbamate, (methacryloxymethyl)silanes, ethoxymethylsilanes, N-phenyl-, N-cyclohexyl- and N-alkylsilanes, orthoformic acid esters, calcium oxide, molecular sieves, or mixtures thereof. The water scavenger can be present in an amount of from 0% (greater than 0%) to 5% by weight, based on the weight of the composition.

Preferably, the acrylic copolymer, the silicone polymer, and the crosslinker are produced under anhydrous conditions. In some instances, a water scavenger can be included during or after polymerization of the acrylic copolymer to capture water. In some embodiments, the compositions comprise less than 0.1% by weight water, preferably less than 0.05% by weight water, more preferably the composition is anhydrous. Preferably, the compositions such as adhesive compositions are also free of isocyanates.

Other suitable additives to the compositions can include defoamers. Defoamers serve to minimize frothing during mixing and/or application of the components. Suitable defoamers include organic defoamers such as mineral oils, silicone oils, and silica-based defoamers. Exemplary silicone oils include polysiloxanes, polydimethylsiloxanes, polyether modified polysiloxanes, or combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Examples of suitable rheology modifiers (thickeners) can include waxes such as polyamide waxes, hydrogenated castor oil derivatives, bentonites, pyrogenic silicic acids, fumed silica-based thickeners, and metal soaps such as calcium stearate, aluminum stearate, barium stearate, and mixtures thereof. In some embodiments, the filler can provide rheological properties to the compositions. In some embodiments, the thickeners can be added to the composition formulation to produce a Brookfield viscosity of 25 Pa·s or greater (e.g., 30 Pa·s or greater, 35 Pa·s or greater, 40 Pa·s or greater, from 25-100 Pa·s, from 25-75 Pa·s, from 25-60 Pa·s, or from 30-60 Pa·s) at 25° C. The Brookfield viscosity can be measured using a Brookfield type viscometer with a #7 spindle at 20 rpm at 25° C.

As described herein, the compositions can include diluents, carriers, or modifiers. Suitable diluents can include an unreactive silicone. The diluent can aid in improving the viscosity and workability of the composition, and/or change the final properties of the composition such as cohesive or adhesive strength. The unreactive silicone does not contain any active functional group capable of participating in the curing or crosslinking reaction. The unreactive silicone can be selected from a high molecular weight solid silicone rubber (SSR) or a low molecular weight silicone oil. The high molecular weight solid silicone rubber or low molecular weight silicone oil can comprise a polydimethylsiloxane silicone rubber or oil, a polymethylvinyl silicone rubber or oil, a polymethylphenyl silicone rubber or oil, or a combination thereof. The molecular weight Mn of the high molecular weight solid silicone rubber can be from 100,000 to 1,000,000, such as from 200,000 to 800,000. The viscosity of the silicone oil may be from 0.65 cps to 1,000,000 cps, such as from 50 cps to 800,000 cps. Unreactive silicones are commercially available as DC200-50 available from Dow Corning. Suitable carriers can include fluid carrier such as cyclomethicones, which are a group of methyl siloxanes, a class of liquid silicones (cyclic polydimethylsiloxane polymers) that possess the characteristics of low viscosity and high volatility. Cyclomethicones have short backbones that make closed or nearly-closed rings with their methyl groups. Octamethylcyclotetrasiloxane, also called D4, is an organosilicon compound with the formula [(CH₃)₂SiO]₄ that generally is less volatile than other cyclomethicones. The amount of diluent, carrier, or modifier used can be from about 0% to 30% by weight, or from about 1% to 10% by weight, based on the total weight of the composition.

Suitable biocides can be incorporated to inhibit the growth of bacteria, algae, fungi, and other microbes in the composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OT), 4,5-dichloro-2-n-octyl-3-isothiazolone, as well as acceptable salts and combinations thereof. Suitable biocides also include biocides that inhibit the growth of mold, mildew, and spores thereof in the compositions. Examples of mildewcides include 2-(thiocyanomethylthio)-benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the composition contains 1,2-benzisothiazolin-3-one or a salt thereof. Biocides of this type include PROXEL® BD20, commercially available from Arch Chemicals, Inc. The biocide can alternatively be applied as a film and a commercially available film-forming biocide is Zinc Omadine® commercially available from Arch Chemicals, Inc.

The compositions can further include stabilizers, for example, against heat, light and UV radiation, antioxidants, tackifier resins, flame-retardant substances, surface-active substances such as crosslinking agents, epoxy resins, epoxy resin-curing agents, photocurable substances, oxygen curable substances, silanol-containing compounds, curability modifiers, radical inhibitors, metal deactivators, flow-control agents, aerating agents, phosphorus-containing peroxide decomposers, lubricants, foaming agents, repellents, and other substances customarily used in moisture-curing compositions.

In some examples, a tackifier resin can be added as necessary to enhance adhesiveness to a substrate. Examples of suitable tackifiers include terpene-based resins, aromatic modified terpene resins, hydrogenated terpene resins, terpene-phenol resins obtained by copolymerizing terpenes with phenols, phenol resins, modified phenol resins, xylene-phenol resins, cyclopentadiene-phenol resins, coumarone-indene resins, rosin resins, rosin ester resins, hydrogenated rosin ester resins, xylene resins, low-molecular weight polystyrene-based resins, styrene copolymer resins, petroleum resins (e.g., C5 hydrocarbon resin, C9 hydrocarbon resin, C5C9 hydrocarbon copolymer resin etc.), hydrogenated petroleum resins, DCPD resins, and the like.

The use of an antioxidant can enhance the heat resistance of the cured product. Examples of the antioxidant include hindered phenol antioxidants, monophenol antioxidants, bisphenol antioxidants, and polyphenol antioxidants. Hindered phenol antioxidants are particularly preferred. Specific examples of the antioxidant also include those disclosed in U.S. Patent Publication No. 2015/0266271. The amount of antioxidant per 100 parts by weight of the copolymer is preferably in the range of 0.1 to 10 parts by weight, and more preferably 0.2 to 5 parts by weight.

The composition can include a photostabilizer to prevent photo oxidative degradation of the cured product. Examples of the photostabilizer include benzotriazole compounds, hindered amine compounds, and benzoate compounds. Hindered amine compounds are particularly preferred. The amount of photostabilizer per 100 parts by weight of copolymer is preferably in the range of 0.1 to 10 parts by weight, and more preferably 0.2 to 5 parts by weight. Specific examples of the photostabilizer are also disclosed in U.S. Patent Publication No. 2015/0266271.

The composition can include an ultraviolet absorber to increase the surface weather resistance of the cured product. Examples of the ultraviolet absorber include benzophenone compounds, benzotriazole compounds, salicylate compounds, substituted tolyl compounds, and metal chelate compounds. Benzotriazole compounds are particularly preferred. The amount of ultraviolet absorber per 100 parts by weight of the copolymer is preferably in the range of 0.1 to 10 parts by weight, and more preferably 0.2 to 5 parts by weight.

Exemplary co-solvents and humectants include ethylene glycol, propylene glycol, diethylene glycol, and combinations thereof.

The composition can further include a solvent to reduce the viscosity of the composition, enhance the thixotropy, and improve the workability. Specific examples of solvents include hydrocarbon solvents such as toluene, xylene, heptane, hexane, and petroleum solvents; halogenated solvents such as trichloroethylene; ester solvents such as ethyl acetate and butyl acetate; ketone solvents such as acetone, methyl ethyl ketone, and methyl isobutyl ketone; ether solvents; alcohol solvents such as methanol, ethanol, and isopropanol; and silicone solvents such as haxamethylcyciotrisiloxane, octamethylcyclotetrasiloxane, and decamethylcyclopentasiloxane. A large solvent content may be toxic to humans and may cause a reduction in cue volume of the cured product, and the like. Thus, the amount of solvent per 100 parts by weight in total of the copolymer is preferably less than 1 part by weight, more preferably less than 0.1 parts by weight, most preferably, substantially no solvent is contained.

As described herein, the hybrid moisture curable compositions described herein can be used in coatings such as roof coatings or adhesive compositions. In some embodiments, the roof coatings or adhesive compositions can include an acrylic copolymer derived from a monomer selected from a silane monomer, a siloxane monomer, a hydroxy functional monomer, or a combination thereof; a functional silicone polymer; a silane based crosslinker; a moisture cure catalyst; at least one type of inorganic filler; an adhesion promoter; optionally a plasticizer or film-forming aid; a defoamer; a rheology modifier (or a thickener); a tackifier; a water scavenger; or a combination thereof.

The acrylic copolymer, functional silicone polymer, silane based crosslinker and the moisture cure catalyst can be present in the compositions in varying amounts so as to provide a resultant composition with the desired properties for a particular application. In some examples, the roof coating composition or adhesive compositions can include from 20-60% by weight of an acrylic copolymer; from 20-60% by weight of a functional silicone polymer; from 0.1-10% by weight of a silane based crosslinker; a moisture cure catalyst; and an inorganic filler. The composition can have a solids weight % of greater than 50%.

Methods

The acrylic copolymer present in the hybrid moisture curable composition disclosed herein can be prepared by any polymerization method known in the art. For example, the acrylic copolymer can be prepared by a method in which a polymer is prepared from one or more (meth)acrylate and one or more carboxylic acid anhydride monomers by the conventional process of free radical solution polymerization, and an aminosilane is stirred into a solution or melt of the polymer, the temperature being from 25° C. to 200° C. The aminosilane can be added immediately post-polymerization of the one or more (meth)acrylate and one or more carboxylic acid anhydride monomers, usually in the course of a few minutes. In other embodiments, the aminosilane can be added during mixing of the acrylic polymer (derived from one or more (meth)acrylates and one or more carboxylic acid anhydrides) with one or more of the functional silicone polymer, the crosslinker, and the moisture cure catalyst to form the acrylic copolymer in situ. In other embodiments, the acrylic copolymer can be prepared by free radical solution polymerization of one or more (meth)acrylate and a monomer selected from a silane monomer, a siloxane monomer, a hydroxy functional monomer, or a combination thereof. In some embodiments, the monomer can include an organosilane monomer.

The solvent for the free radical solution polymerization can include an organic solvent. Examples of suitable solvents include ethers, such as tetrahydrofuran or dioxane, esters, such as ethyl acetate or n-butyl acetate, ketones, such as acetone or cyclohexanone, N,N-dialkylcarboxamide, such as N,N-dimethylformamide, N,N-dimethylacetamide or N-methyl-2-pyrrolidone, aromatics, such as toluene or xylene, aliphatic hydrocarbons, such as isooctane, chlorohydrocarbons, such as tert-butyl chloride, or plasticizers, such as di-n-butyl phthalate. Suitable initiators of free radical polymerization are organic azo compounds or organic peroxides, such as azobisisobutyronitrile, dibenzoyl peroxide or tert-butyl perbenzoate. Chain-transfer agents, such as aliphatic, aromatic or alicyclic mercaptans, e.g. n-butyl mercaptan or n-lauryl mercaptan, or alkyl thioglycolates, such as ethyl thioglycolate, are among the substances which can be added as further assistants. When used, preferred chain-transfer agents are mercaptoalkoxysilanes. In some examples, the polymerization is carried out without a chain transfer agent.

The solution polymerization can be carried out either as a batch, semi-batch, or continuous process. In some embodiments, a portion of the monomers can be heated to the polymerization temperature and partially polymerized, and the remainder of the polymerization batch can be subsequently fed to the polymerization zone continuously, in steps or with superposition of a concentration gradient. The process can use a single reactor or a series of reactors as would be readily understood by those skilled in the art.

In some embodiments, the acrylic copolymer solution can be prepared by first charging a reactor with suitable monomers and optionally a solvent. When a solvent is used, the solvent can include an organic solvent. The initial charge can then be heated to a temperature at or near the reaction temperature. As described herein, the reaction temperature can be, for example, between 70° C. and 250° C. (e.g., between 80° C. and 120° C., between 70° C. and 110° C., between 90° C. and 120° C.). For high temperature polymerization, the reaction temperature can be, for example, between 120° C. and 250° C. (e.g., between 150° C. and 250° C., or between 150° C. and 220° C.).

After the initial charge, the monomers that are to be used in the polymerization can be continuously fed to the reactor in one or more monomer feed streams. The monomers can be supplied as a solution. An initiator feed stream can also be continuously added to the reactor at the time the monomer feed stream is added although it may also be desirable to include at least a portion of the initiator solution to the reactor before adding a monomer stream if one is used in the process. The monomer and initiator feed streams are typically continuously added to the reactor over a predetermined period of time (e.g., 1.5-24 hours) to cause polymerization of the monomers and to thereby produce the polymer solution or melt.

As mentioned above, the monomer feed stream can include one or more monomers (e.g., a carboxylic acid anhydride, a (meth)acrylate monomer, an organosilane, and optionally additional monomers). The monomers can be fed in one or more feed streams with each stream including one or more of the monomers being used in the polymerization process. For example, the carboxylic acid anhydride, and the (meth)acrylate monomer can be provided in separate monomer feed streams. It can also be advantageous to delay the feed of certain monomers to provide certain polymer properties.

The initiator feed stream can include at least one initiator or initiator system that is used to cause the polymerization of the monomers in the monomer feed stream. The initiator stream can also include a solvent and other desired components appropriate for the monomer reaction to be initiated. The initiator can be any initiator known in the art for use in solution polymerization such as disclosed herein.

Once polymerization is completed, the polymer solution or melt can be stripped thereby decreasing its residual monomer content. This stripping process can include a physical stripping step. In some embodiments, the polymer solution or melt is physically stripped by evaporation. Once the stripping step is completed, additives including defoamers, coalescing aids, water scavengers, or a plasticizer can be added or at a later time if desired. Once the polymerization reaction is complete, and the stripping step is completed, the temperature of the reactor can be reduced.

As described herein, an anhydrous polymerization medium, i.e. one having a water content of less than 100 ppm, is advantageously used. The solution polymerization of the essentially anhydrous reactants can be carried out in the presence of small amounts of drying agents, such as tetraalkoxysilanes, e.g. tetramethoxysilane, or trialkyl orthoformates, eg. triethyl orthoformate, with or without the addition of a Lewis acid. If required, the solvent can be separated off partially or completely from the resulting solutions of the starting polymers, for example by distillation under reduced pressure.

The acrylic copolymers can be obtainable in the presence or absence of a solvent by stirring an aminosilane into melts or solutions of the polymers, the reaction generally taking place within a few minutes even at room temperature.

The hybrid moisture curable compositions can be formulated by mixing the acrylic copolymer derived from a monomer selected from a silane monomer, a siloxane monomer, a hydroxy functional monomer, or a combination thereof with a functional silicone polymer, a crosslinker, and a moisture cure catalyst to form a mixture. The mixture can be prepared in the form of a single-component system in which all components are mixed, and then stored in a sealed container. However, it can also be used in the form of a two-component system in which the acrylic polymer derived from one or more (meth)acrylates and one or more carboxylic acid anhydrides, the functional silicone polymer, the crosslinker, and the other components that are not the aminosilane (such as filler, catalyst, optional thickener, defoamer, water scavenger, film forming aid, and adhesion enhancer) are mixed to form one component, into which the aminosilane can be stirred as the second component before use. Particular care must be taken to exclude water since premature curing of the components can occur.

The acrylic copolymer, the functional silicone polymer, and the crosslinker can react to form a covalently bonded material. The acrylic copolymer, functional silicone polymer, and the crosslinker compositions are characterized by curing which takes place rapidly, even at room temperature, under the action of atmospheric humidity and can be accelerated, if required, by adding a moisture cure catalyst. As described herein, the compositions can further include external plasticizers, inert fillers, thickeners, dyes, solvents, agents for increasing the aging resistance or active ingredients which accelerate curing by the action of atmospheric humidity. The amounts of additives are familiar to the skilled worker and are selected in accordance with the desired properties of the particular compound and advantageously stirred into the solutions or melts of the mixture.

As disclosed herein, the hybrid compositions can be used in various compositions. The compositions can be used for several applications, including roof coatings (e.g., asphalt roofing compounds), adhesives such as flooring adhesives, membranes, films, water-proof coatings, sealants, roof coatings, paints, carpet backing, foams, textiles, sound absorbing compounds, tape joint compounds, or asphalt-aggregate mixtures.

The hybrid moisture curable composition can be applied to a surface by any suitable coating technique, including spraying, rolling, brushing, or spreading (for example using a trowel). The hybrid moisture curable composition can be applied in a single coat, or in multiple sequential coats (e.g., in two coats or in three coats) as required for a particular application. Generally, the composition is allowed to dry under ambient conditions. However, in certain embodiments, the hybrid moisture curable composition can be dried, for example, by heating and/or by circulating air over the composition. The composition can have a thickness of 2 mils or greater, such as 5 mils or greater, 10 mils or greater, 15 mils or greater, 20 mils or greater, or 25 mils or greater. In some embodiments, the composition can have a thickness of 30 mils or less, such as 25 mils or less, 20 mils or less, 15 mils or less, 10 mils or less, or 5 mils or less.

The open time of the compositions can be at least 20 minutes, such as at least 25 minutes or at least 30 minutes. Open time refers to the time after applying the composition on a surface, and thus exposed to the atmosphere, that the composition can still adhere (wet) at least 50% of the substrate surface area. The compositions, such as roof coating composition, can have a tack-free time of less than 24 hours at room temperature.

The compositions, when applied as a film and cured, can develop a tensile strength of at least 50 psi, such as at least 90 psi, or at least 100 psi after 5 days. The tensile strength can be determined using the following method: films of the compositions are drawn down with a 10 mil ( 1/100 inch) bar on a teflon board. The films are cured for 7 to 10 days at standard ambient conditions (72+/−2° F. and 50%+/−5% relative humidity). From the cured films, dogbone-shaped specimens with dimensions 75 mm×4 mm are cut out with a die cutter, and tensile strength testing is performed with an Instron machine at 7.9 inch/min crosshead speed with 1 inch gap size.

The compositions, when applied as a film and cured, can develop an elongation at break of at least 30%, such as at least 70%, or at least 100% after 5 days. The elongation at break can be determined using the following methods: Method A for non-pigmented films: Films of the compositions are drawn down with a 30 mil (3/100 inch) bar on a teflon board. The films are cured for 7 to 10 days at standard ambient conditions (72+/−2° F. and 50%+/−5% relative humidity). From the cured films, dogbone-shaped specimens with dimensions 75 mm×4 mm are cut out with a die cutter, and elongation at break testing is performed with an Instron tensile testing machine with 0.5 inch gap and 7.9 inch/min cross-head speed. Method B for pigmented films: Films of the compositions are drawn down with a 30 mil (3/100 inch) bar on a teflon board. The films are cured for 7 to 10 days at standard ambient conditions (72+/−2° F. and 50%+/−5% relative humidity). From the cured films, rectangular specimens with dimensions 75 mm×13 mm are cut out with a die cutter, and elongation at break testing is performed with an Instron tensile testing machine with 0.5 inch gap and 1.0 inch/min cross-head speed.

The compositions, when applied as a film and cured, can exhibit a water absorbance of less than 10%, preferably less than 5%, more preferably less than 3% after 7 days of soaking. The water absorbance of the films corresponds to the percentage weight gain of an approximately 2.0 g film specimen after soaking in water for 24 h or the specified time.

The compositions, when applied as a film and cured, can exhibit an adhesion rating on a silicone surface of at least 5, at least 6 or at least 7. The adhesion rating of the films can be determined by observing the adhesion of the films to a substrate. The test was used with 15-20 mil film thicknesses applied to a silicone substrate. A relative adhesion value is assigned to the pulled specimens, based on a scale of 1-9, where 1 is no adhesion, and 9 is the highest adhesion representing a film that cannot be removed from the substrate.

Methods of using the hybrid curable compositions to adhere two surfaces are also disclosed. The method of adhering two surfaces can include applying the hybrid curable composition to at least a first surface, bringing a second surface into contact with the first surface, and allowing the adhesive composition to cure. In some embodiments, the hybrid curable composition can be dry to the touch in less than 4 hours, preferably less than 2 hours.

By way of non-limiting illustration, examples of certain embodiments of the present disclosure are given below.

### EXAMPLES

### Example 1: Preparation of Curable Adhesive Formulations

Exemplified herein are moisture curable compositions comprising copolymers of silyl-acrylates, functional silicones and silane cross-linkers. The silane functionality on the acrylic copolymer imparts the ability to chemically crosslink with silicone-based building blocks. More specifically, the exemplified compositions are anhydrous curable compositions comprising (a) an acrylic resin with silane functionality that is capable of moisture cure, (b) a polysiloxane (silicone) with OH, NH₂ or SH functional group, (c) a silane-based tris-oxime crosslinker, and (d) a moisture-cure catalyst.

In this example, an acrylic copolymer resin with silane functionality was made by high-temperature radical polymerization including co-feeding suitable monomers and a catalyst. The monomers comprise of one or more acrylate esters and at least trimethoxysilylpropyl-methacrylate or a monomer with a R₁R₂R₃Si-group, where R₁, R₂ and R₃ are independently of one another being alkoxy or alkyl. Alternatively, the acrylic copolymer resin with silane functionality was prepared by post-functionalization of an acrylic copolymer with maleic anhydride functions with an aminosilane. The acrylic copolymer resin exhibited a viscosity of 50,000 centipoise (50 Pa s) or less, such as 30,000 centipoise (30 Pa s) or less. The resulting cured materials combine attributes of an acrylic polymer and a silicone polymer, thus good cohesive strength, durability, weatherability and adhesion from the acrylic, and water resistance and chemical resistance from the silicone.

Materials and Methods: ANDISIL OH70 and OH750 are hydroxy-silicones having a PDMS backbone structure (both commercially available from AB Specialty Silicones). ANDISIL OH70 is a low molecular weight silicone having a viscosity of about 70 cp. OH750 is a higher molecular weight silicone having a viscosity of about 750 cP. ANDISIL MOS is a methylsilane tris-oxime cross-linker, commercially available from AB Specialty Silicones. BorchiKat 324 and 24 (based on metal carboxylate available from Borchers®), as well as TYZOR 9000 are tin-free metal-based moisture-cure catalysts.

Curable coating formulations were prepared according to Table 1 and investigated for their cure speed. Resin A is a silyl-acrylate resin based on n-butylacrylate and TMSMA (3-trimethoxysilyl-propyl methacrylate), synthesized in presence of the water scavenger TMOA (trimethyl orthoacetate). Resin B is a silyl-acrylate resin based on n-butylacrylate and TMSMA; with no TMOA. Resin C is a silyl-acrylate resin based on n-butylacrylate and TESMA (3-triethoxysilyl-propyl methacrylate), with no TMOA.

TABLE 1
Curable compositions

| | Sample 1 | CS I | CS II | CS III | CS IV | CS V |
|---|---|---|---|---|---|---|
| Resin A, g | 10 | 0 | 10 | 0 | 0 | 0 |
| Resin B, g | 0 | 10 | 0 | 0 | 0 | 0 |
| Resin C, g | 0 | 0 | 0 | 0 | 0 | 10 |
| OH 70, g | 0 | 0 | 0 | 10 | 0 | 0 |
| OH 750, g | 10 | 10 | 10 | 0 | 10 | 0 |
| ANDISIL MOS, g | 0.5 | 0.5 | 0 | 0.5 | 0.5 | 0.5 |
| BorchiKat 324, g | 0.4 | 0 | 0.4 | 0.4 | 0.4 | 0.4 |
| Mixture cure | Pass | Fail (mixture | Fail (mixture | Fail (mixture | Fail (mixture | Fail (liquid |
| after 1 day | (mixture is | is still liquid | is still liquid | is still | is solid, but | with gel, thin |
| | mostly set in | and very | and very | entirely | very soft and | skim on top) |
| | a solid gel) | sticky) | sticky) | liquid) | poor cohesive | |
| | | | | | strength) | |

Sample 1 is an inventive hybrid moisture curable adhesive.
Comparative Sample I (CS I) is a comparable composition without catalyst.
Comparative Sample II (CS II) is a comparable composition without crosslinker.
Comparative Sample III (CS III) is a comparable composition without silyl-acrylic copolymer.
Comparative Sample IV (CS IV) is a comparable composition without silyl-acrylic copolymer.
Comparative Sample V (CS V) is a comparable composition without silicone.

Summary of the results in Table 1: the curable blend of silyl-acrylic resin and hydroxy-silicone (OH 70 or OH750) with silane crosslinker (MOS) and moisture-cure catalyst resulted in a solid gel after one day. When the catalyst, the crosslinker or the hydroxy silicone was excluded, the cure was incomplete, or no reaction occurred. When the silyl-acrylic resin was excluded, the cure depended on the molecular weight of the hydroxy-silicone: low-MW OH70 mix shows evidence of no or little cure, whereas high-MW OH750 cures, but into a very soft gel with little cohesive strength.

### Example 2: Preparation of Curable Coating Formulations

Curable coating formulations were prepared according to Table 2 and investigated for their cure speed.

TABLE 2
Curable compositions

| | | ANDISIL | ANDISIL | TYZOR | |
|---|---|---|---|---|---|
| | Resin C, | OH750, | MOS, | 9000, | Mixture cure |
| | g | g | g | g | after 1 day |
| Sample 2 | 10 | 10 | 1 | 0.4 | Pass (mixture |
| | | | | | is completely |
| | | | | | set) |
| CS VI | 10 | 10 | 0 | 0.4 | Fail (mixture |
| | | | | | has solid skin |
| | | | | | on top but is |
| | | | | | liquid below) |

Sample 2 is an inventive hybrid moisture curable composition.
Comparative Sample VI (CS VI) is a comparable composition without crosslinker.

Summary of the results in Table 2: the curable blend of silyl-acrylic resin and hydroxy-silicone (OH 70 or OH750) with silane crosslinker (MOS) and moisture-cure catalyst resulted in a solid gel after one day. When the crosslinker was excluded, the cure was incomplete, even after 18 days.

### Example 3: Preparation of Curable Coating Formulations

Curable coating formulations were prepared according to Table 3 and investigated for their cure speed.

TABLE 3
Curable compositions

| | Sample 3 | Sample 4 | Sample 5 | Sample 6 | Sample 7 | Sample 8 |
|---|---|---|---|---|---|---|
| Resin A, g | 10 | 0 | 0 | 10 | 0 | 0 |
| Resin B, g | 0 | 10 | 0 | 0 | 10 | 0 |
| Resin C, g | 0 | 0 | 10 | 0 | 0 | 10 |
| OH 70, g | 10 | 10 | 10 | 0 | 0 | 0 |
| OH 750, g | 0 | 0 | 0 | 10 | 10 | 10 |
| ANDISIL MOS, g | 1 | 1 | 1 | 1 | 1 | 1 |
| BorchiKat 324, g | 0.4 | 0.4 | 0.4 | 0.4 | 0.4 | 0.4 |
| Total, g | 21.4 | 21.4 | 21.4 | 21.4 | 21.4 | 21.4 |
| Mixture cure | top is set, | top is set, | top is set, | mostly | mostly | liquid with |
| after 2 days | liquid below | sticky liquid | liquid below | liquid, skim | liquid, skim | gel, thin |
| | | below | | on top | on top | skim on top |
| Mixture cure | 90% set | Fully set | 90% set | Fully set | Fully set | 90% set |
| after 17 days | | | | | | |

Samples 3-8 are inventive hybrid moisture curable compositions.

Summary of the results in Table 3: the curable blend of silyl-acrylic resin and hydroxy-silicone (OH 70 or OH750) with silane crosslinker (MOS) and moisture-cure catalyst resulted in a solid gel. TMSMA (methoxysilane) functional acrylic resins appear to cure faster than TESMA (ethoxysilane) functional resins. The use of the higher MW hydroxy-silicone (OH750) appears to cure faster than the lower MW one (OH70).

### Example 4: Preparation of Curable Coating Formulations

Curable coating formulations were prepared according to Table 4 and films formed therefrom investigated for their cure properties. Water absorption and tensile strength were also determined as follows: thin layers (25 mil) of the compositions were drawn down on a Teflon board and allowed to cure for five days. Film specimens were then cut for determining water absorption (1″ by 1″ discs) and for tensile measurements (dog-bone shapes). For each of the water absorption and tensile tests in Table 4, an average of three specimens is reported.

TABLE 4
Curable compositions

| | Sample 9 | Sample 10 | Sample 11 | Sample 12 | Sample 13 | Sample 14 |
|---|---|---|---|---|---|---|
| Resin A, g | 25.0 | 0 | 0 | 25.0 | 0 | 0 |
| Resin B, g | 0 | 25.0 | 0 | 0 | 25.0 | 0 |
| Resin C, g | 0 | 0 | 25.0 | 0 | 0 | 25.0 |
| OH 70, g | 25.0 | 25.0 | 25.0 | 25.0 | 25.0 | 25.0 |
| ANDISIL MOS, | 2.5 | 2.5 | 2.5 | 2.5 | 2.5 | 2.5 |
| g | | | | | | |
| TYZOR 9000, g | 1.0 | 1.0 | 1.0 | 0 | 0 | 0 |
| TYZOR PITA | 0 | 0 | 0 | 1.0 | 1.0 | 1.0 |
| SM, g | | | | | | |
| Total, g | 52.5 | 52.5 | 52.5 | 52.5 | 52.5 | 52.5 |
| Water abs. 72 | 0.0% | 0.0% | 0.0% | 0.3% | 0.2% | 0.0% |
| hrs soak | | | | | | |
| Tensile (psi) | 32 | 43 | 35 | 38 | 36 | 44 |
| Elongation at | 113% | 121% | 81% | 146% | 115% | 119% |
| break | | | | | | |

After 3 days soaking in water:

| | | | | | | |
|---|---|---|---|---|---|---|
| Tensile (psi) | 44 | 47 | 47 | 36 | 40 | 48 |
| Elongation at | 144% | 149% | 146% | 161% | 143% | 136% |
| break | | | | | | |

Samples 9-14 are inventive hybrid moisture curable compositions.

Summary of the results in Table 4: All the inventive compositions were completely or almost completely set after 3 days. The films formed were water-resistant, virtually zero absorption after three days of soaking. Tensile-elongation data improve after three days soaking.

### Example 5: Preparation of Curable Coating Formulations

Curable coating formulations were prepared according to Table 5 and films formed therefrom investigated for their cure properties. Resin D is a silyl-acrylate resin based on n-butylacrylate and 5 wt % TMSMA (low Tg resin). Resin E is a silyl-acrylate resin based on n-butylacrylate, methylmethacrylate, and 5 wt % TMSMA (high Tg resin).

Water absorption and tensile strength were also determined as described herein.

TABLE 5
Curable compositions

| | Sample 15 | Sample 16 | Sample 17 | Sample 18 | Sample 19 | Sample 20 |
|---|---|---|---|---|---|---|
| Resin D, g | 46.7 | 0 | 46.7 | 0 | 23.9 | 0 |
| Resin E, g | 0 | 46.7 | 0 | 46.7 | 0 | 23.9 |
| OH 750, g | 46.7 | 46.7 | 46.7 | 46.7 | 71.8 | 71.8 |
| ANDISIL | 4.7 | 4.7 | 2.4 | 2.4 | 4.7 | 4.7 |
| MOS, g | | | | | | |
| TYZOR | 1.9 | 1.9 | 1.9 | 1.9 | 1.9 | 1.9 |
| 9000, g | | | | | | |
| Total, g | 98.1 | 98.1 | 95.8 | 95.8 | 100.4 | 100.4 |
| Water abs. | 0.1% | 0.1% | 0.1% | 0.5% | 0.1% | 0.0% |
| 72 hrs soak | | | | | | |
| Tensile | 35 | 58 | 66 | 45 | 76 | 54 |
| (psi) | | | | | | |
| Elongation | 113% | 111% | 210% | 116% | 201% | 103% |
| at break | | | | | | |

Samples 15-20 are inventive hybrid moisture curable compositions.

### Example 6: Preparation of Curable Roofing. Formulations with Pigments

Curable coating formulations were prepared according to Tables 6 and 7 and investigated for their use as roof coatings.

TABLE 6
Curable compositions with pigments

| | Sample | | | | | |
|---|---|---|---|---|---|---|
| | 21 | Sample 22 | Sample 23 | Sample 24 | Sample 25 | CS VII |
| Resin D, g | 24.6 | 24.6 | 24.6 | 24.6 | 12.3 | 0 |
| ANDISIL OH 750, g | 24.6 | 24.6 | 24.6 | 24.6 | 36.9 | 49.2 |
| ANDISIL MOS, g | 4.6 | 3.0 | 4.6 | 4.6 | 4.6 | 4.6 |
| Ti-Pure R-960, g | 6.3 | 6.3 | 6.3 | 6.3 | 6.3 | 6.3 |
| Duramite, g | 37.4 | 37.4 | 37.4 | 37.4 | 37.4 | 37.4 |
| Dynasylan 1505, g | 0.9 | 0.9 | 0.9 | 0.9 | 0.9 | 0.9 |
| TYZOR 9000, g | 1.5 | 1.5 | 2.5 | 0 | 1.5 | 1.5 |
| BorchiKat 324, g | 0 | 0 | 0 | 1.5 | 0 | |
| Total, g | 99.9 | 98.3 | 100.9 | 99.9 | 99.9 | |
| Water abs. 7 days | 4.3% | 2.6% | 2.6% | 13.4% | 3.2% | |
| soak | | | | | | |
| Tensile (psi) | 58 | 91 | 56 | 103 | 127 | |
| Elongation at break | 38% | 74% | 41% | 110% | 90% | |
| Shelf Life | Pass | Pass | Pass | Pass | Pass | Fail (mixture does |
| | | | | | | not have any |
| | | | | | | significant open |
| | | | | | | time, and sets up in |
| | | | | | | the mixing vessel) |

Samples 21-25 are inventive hybrid moisture curable compositions.

Summary: The moisture-curable compositions based on acrylic and silicone building blocks exhibited fast drying times, display high cohesive strength, good durability, excellent water resistance and can adhere to different substrates. The moisture-cure reaction was fast and does not need toxic tin-based catalysts. The curable adhesive compositions are free of solvents, free of isocyanates, and have a low-VOC. Therefore, the compositions are environmentally benign and non-toxic.

When used as roof coatings, the resulting compounds combine advantages of acrylic copolymers, such as good tear propagation resistance, durability and adhesion, and the advantages of silicones, especially excellent water resistance.

### Example 7: Preparation of Curable Compositions

Curable formulations were prepared according to Table 7. Resins F and G are silyl-acrylate resins based on n-butyl acrylate, methyl methacrylate, and 5 wt % TMSMA (high Tg resin). Resin H is a hydroxy functional resin based on n-butyl acrylate, methyl methacrylate and 10% hydroxyethyl methacrylate.

The curable formulations were drawn down on a Teflon board, allowed to cure, and their film properties characterized. In cases where the formulations spread evenly produced uniform films, the films were indicated as a pass and their cure properties further investigated. Particularly, water absorption, tensile strength, and elongation were determined. The comparative sample, without the presence of an acrylic resin, failed in that the composition exhibited dewetting on the substrate.

TABLE 7
Curable compositions

| | Sample | Sample | Sample | Sample | Sample | Sample | Sample | CS |
|---|---|---|---|---|---|---|---|---|
| | 26 | 27 | 28 | 29 | 30 | 31 | 32 | VIII |
| Resin F, g | 24.6 | 0 | 24.6 | 36.9 | 12.3 | 0 | 0 | 0 |
| Resin G, g | 0 | 24.6 | 0 | 0 | 0 | 0 | 0 | 0 |
| Resin H, g | 0 | 0 | 0 | 0 | 0 | 24.6 | 12.3 | 0 |
| OH 750, g | 24.6 | 24.6 | 24.6 | 12.3 | 36.9 | 24.6 | 36.9 | 49.2 |
| Vinyltrimethoxysilane, | 1.0 | 1.0 | 1.0 | 1.0 | 1.0 | 1.0 | 1.0 | 1.0 |
| g | | | | | | | | |
| ANDISIL MOS, g | 2.5 | 2.5 | 2.5 | 2.5 | 2.5 | 2.5 | 2.5 | 2.5 |
| TYZOR 9000, g | 0.5 | 0.5 | 0.8 | 0.8 | 0.8 | 0.8 | 0.8 | 0.8 |
| Total, g | 53.2 | 53.2 | 53.5 | 53.5 | 53.5 | 53.5 | 53.5 | 53.5 |
| Spreading on substrate | PASS | PASS | PASS | PASS | PASS | PASS | PASS | FAIL |
| Water abs. 72 hrs soak | 0.9% | 0.4% | 0.2% | 0.3% | 0.1% | 0.8% | 0.2% | |
| Tensile (psi) | 96 | 118 | 141 | 65 | 80 | 54 | 74 | |
| Elongation at break | 165% | 209% | 191% | 112% | 162% | 366% | 298% | |

Samples 26-32 are inventive hybrid moisture curable compositions.

### Example 8: Preparation of Curable Roofing Compositions

Curable formulations for roof coatings were prepared according to Table 8. Resins F and G are as described above, silyl-acrylate resins based on n-butyl acrylate, methyl methacrylate, and 5 wt % TMSMA (high Tg resin). Resin I is a silyl-acrylate resin based on 2-ethylhexyl acrylate, and 10% TESMA.

TABLE 8
Curable compositions with pigments

| | Sample 33 | Sample 34 | Sample 35 |
|---|---|---|---|
| Resin F, g | 24.8 | 0 | 0 |
| Resin G, g | 0 | 24.8 | 0 |
| Resin I, g | 0 | 0 | 24.8 |
| ANDISIL OH 750, g | 24.8 | 24.8 | 24.8 |
| ANDISIL MOS, g | 4.6 | 4.6 | 4.6 |
| Ti-Pure R-960, g | 6.3 | 6.3 | 6.3 |
| Duramite, g | 37.6 | 37.6 | 37.6 |
| Dynasylan 1505, g | 0.9 | 0.9 | 0.9 |
| Aerosil 200, g | 1.0 | 1.0 | 1.0 |
| TYZOR 9000, g | 0.8 | 0.8 | 0.8 |
| Total, g | 100.8 | 100.8 | 100.8 |
| Tensile (psi) | 124 | 113 | 46 |
| Elongation at break | 61% | 65% | 45% |

Samples 33-35 are inventive hybrid moisture curable compositions.

### Example 9: Preparation of Curable Compositions

Curable formulations were prepared according to Table 9. Resin J is a silyl-acrylate resin based on n-butyl acrylate, methyl methacrylate, and 6 wt % TMSMA (high T_{g} resin having a calculated Fox-T_{g} 0′° C.).

TABLE 9
Curable compositions

| | | Sample | Sample | Sample | |
|---|---|---|---|---|---|
| | CS IX | 36 | 37 | 38 | CS X |
| Resin J, g | 49.2 | 36.9 | 24.6 | 12.3 | 0 |
| ANDISAIL OH 750, g | 0 | 12.3 | 24.6 | 36.9 | 49.2 |
| ANDISIL MOS, g | 2.5 | 2.5 | 2.5 | 2.5 | 2.5 |
| TYZOR 9000, g | 0.8 | 0.8 | 0.8 | 0.8 | 0.8 |
| Total, g | 52.5 | 52.5 | 52.5 | 52.5 | 52.5 |
| Water abs. 72 hrs soak | 0.3% | 0.4% | 0.2% | 0.3% | 0.1% |
| Tensile (psi) | 78 | 138 | 161 | 74 | 62 |
| Elongation at break | 80% | 123% | 200% | 196% | 245% |

Samples 36-38 are inventive hybrid moisture curable compositions.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1.-54. (canceled)

55. A composition, comprising:
an acrylic copolymer derived from (i) a functional monomer selected from a silane monomer, a siloxane monomer, a hydroxy functional monomer, or a combination thereof, or (ii) a reaction product of an aminosilane and an acrylic polymer derived from one or more (meth)acrylates and one or more carboxylic acid anhydrides;
a functional silicone polymer;
a crosslinker; and
a moisture cure catalyst.

56. The composition of claim 55, wherein the acrylic copolymer is derived from monomers including a (meth)acrylate and an organosilane or an organosiloxane.

57. The composition of claim 56, wherein the organosilane or organosiloxane comprises a vinyl silane, a silane (meth)acrylic monomer, a siloxane (meth)acrylic monomer, or a combination thereof.

58. The composition of claim 56, wherein the organosilane or organosiloxane is selected from a trialkoxylsilyl (meth)acrylate such as (3-methacryloxypropyl)-trimethoxysilane, (3-methacryloxypropyl)-triethoxysilane, (3-methacryloxypropyl)-triisopropoxysilane; a dialkoxylsilyl (meth)acrylate such as (3-methacryloxypropyl)-methyldiethoxysilane, dimethoxymethylsilyl methyl (meth)acrylate, or diethoxymethylsilyl methyl (meth)acrylate; a vinyltrialkoxysilane such as vinyltrimethoxysilane, vinyltriethoxysilane, vinyl triisopropoxysilane, or vinyl tris(2-methoxyethoxysilane); 2-methyl-2-propenoic acid 3-[tris-(1-methylethoxy)-silyl]-propyl ester; or a combination thereof.

59. The composition of claim 55, wherein the acrylic copolymer is derived from greater than 0% to 15% by weight, of the organosilane or organosiloxane, based on a total weight of monomers in the acrylic copolymer.

60. The composition of claim 55, wherein the acrylic copolymer is derived from a hydroxy functional monomer.

61. The composition of claim 55, wherein the hydroxy functional monomer comprises hydroxyethyl acrylate, hydroxypropyl acrylate, hydroxy methylethyl acrylate, hydroxyethyl acrylamide, hydroxybutyl acrylate, hydroxyethyl methacrylate, hydroxyethyl methacrylate, hydroxypropyl methacrylate, glycerol monomethacrylate, hydroxypropyl)methacrylamide, or a combination thereof.

62. The composition of claim 55, wherein the acrylic copolymer is derived from greater than 0% to 30% by weight, of the hydroxy functional monomer.

63. The composition of claim 55, wherein the acrylic copolymer is a reaction product of an aminosilane and an acrylic polymer derived from one or more (meth)acrylates and one or more carboxylic acid anhydrides.

64. The composition of claim 63, wherein the acrylic copolymer is derived from greater than 0% to 10% by weight, based on the total weight of monomers in the acrylic copolymer.

65. The composition of claim 63, wherein the one or more carboxylic acid anhydrides are selected from the group consisting of a (meth)acrylic anhydride, an itaconic anhydride, a citraconic anhydride, a maleic anhydride, and a combination thereof.

66. The composition of claim 63, wherein the acrylic copolymer is derived from greater than 0% to 15% by weight, of the one or more carboxylic acid anhydrides, based on the total weight of monomers in the acrylic copolymer.

67. The composition of claim 55, wherein the acrylic copolymer includes one or more (meth)acrylates selected from the group consisting of butyl acrylate, ethyl acrylate, 2-ethylhexyl acrylate, methyl methacrylate, and combinations thereof.

68. The composition of claim 55, wherein the acrylic copolymer is derived from 60% to 95% by weight of the one or more (meth)acrylates, based on the total weight of monomers in the acrylic copolymer.

69. The composition of claim 55, wherein the acrylic copolymer further comprises one or more additional monomers selected from an ethylenically unsaturated carboxylic acid monomers, a (meth)acrylamide, a styrene, a hydroxyethyl acrylate, or a combination thereof.

70. The composition of claim 55, wherein the acrylic copolymer has a measured T_{g} of from −60° C. to 40° C.

71. The composition of claim 55, wherein the acrylic copolymer has a weight average molecular weight of from 1,000 Daltons to 20,000 Daltons.

72. The composition of claim 55, wherein the acrylic copolymer is present in an amount of from 5% to 80% by weight, based on a total weight of the composition.

73. The composition of claim 55, wherein the functional silicone polymer comprises a hydroxyl functional group, an amine functional group, a thiol functional group, an alkoxy functional group, a hydride functional group, a vinyl functional group, or a mixture thereof.

74. The composition of claim 55, wherein the functional silicone polymer comprises a polysiloxane backbone, preferably a polydialkylsiloxane backbone, more preferably a polydimethylsiloxane backbone.
